(19) United States
(12) Patent Application Publication
(10) Pub. No.: US 2013/0157090 A1
(43) Pub. Date: Jun. 20, 2013

(54) SECONDARY BATTERY, AND METHOD FOR MANUFACTURING SECONDARY BATTERY

(71) Applicant: Akira Kuroda, Toyota-shi (JP)

(72) Inventor: Akira Kuroda, Toyota-shi (JP)

(21) Appl. No.: 13/818,189

(22) PCT Filed: Sep. 1, 2010
(86) PCT No.: PCT/JP2010/064958

§ 371 Date: Feb. 21, 2013

(51) Int. Cl. H01M 2/38

(52) U.S. Cl. CPC H01M 2/38
USPC 429/72; 29/623.1

(57) ABSTRACT

A lithium ion secondary battery (secondary battery) is provided with a wound electrode body formed by a positive electrode plate and a negative electrode plate overlapping each other with a separator therebetween and being wound around an axis. The wound electrode body comprises a one side fluid flow restrictor which is formed in one axial end portion of the electrode body central part thereof and suppresses the flow of an electrolytic solution through the one axial end portion, and the other side fluid flow restrictor which is formed in the other axial end portion of the electrode body central part and suppresses the flow of the electrolytic solution through the other axial end portion.

### CROSS-REFERENCE TO RELATED APPLICATIONS

This application is a national phase application of International Application No. PCT/JP2010/064958, filed Sep. 1, 2010, the content of which is incorporated herein by reference.

### TECHNICAL FIELD

The present invention relates to a secondary battery having a wound electrode body formed by winding elongated positive and negative electrode plates overlapped upon one another via an elongated separator interposed therebetween around an axis. The invention also relates to a method for manufacturing this secondary battery.

### BACKGROUND ART

Conventionally, secondary batteries such as lithium ion secondary batteries with wound electrode bodies formed by winding elongated positive and negative electrode plates overlapped upon one another via an elongated separator around an axis are known. Of these, the positive electrode plate is made up of a strip of positive current collecting foil and positive active material layers formed thereon, and includes a strip-shaped positive electrode portion extending in a longitudinal direction and a strip-shaped positive current collecting portion located at one end in a width direction of the positive electrode plate and extending in the longitudinal direction. The negative electrode plate is made up of a strip of negative current collecting foil and negative active material layers formed thereon, and includes a strip-shaped negative electrode portion extending in the longitudinal direction and a strip-shaped negative current collecting portion located at one end in a width direction of the negative electrode plate and extending in the longitudinal direction. The wound electrode body includes an electrode body central part in which the separator exists in a radial direction of the axis. A part of the positive current collecting portion in the width direction protrudes in a spiral shape from this electrode body central part toward one axial end side, and a part of the negative current collecting portion in the width direction protrudes in a spiral shape from the electrode body central part toward the other axial end side.

When such a secondary battery is discharged at a high rate in low temperature environments, the electrolyte inside the wound electrode body is subjected to pressure because of expansion of active materials and thermal expansion of the wound electrode body. As the battery is discharged, the concentration of ions such as lithium ions contained in the electrolyte for electrical conduction is increased near the negative active material layers, and this electrolyte with higher ion concentration is pushed out from inside to outside of the wound electrode body. Therefore, when the battery is repeatedly discharged at a high rate in low temperature environments, the ion concentration of the electrolyte inside the electrode body is gradually decreased. This means that there are fewer ions that can contribute to the battery reaction inside the electrode body, as a result of which the internal resistance is increased and the apparent battery capacity is reduced.

Contrarily, when this secondary battery is charged at a high rate in low temperature environments, the electrolyte inside the wound electrode body is also subjected to pressure because of expansion of active materials and thermal expansion of the wound electrode body. As the battery is charged, the concentration of ions in the electrolyte is decreased near the negative active material layers, and this electrolyte with lower ion concentration is pushed out from inside to outside of the wound electrode body. Therefore, when the battery is repeatedly charged at a high rate in low temperature environments, the ion concentration of the electrolyte inside the electrode body is gradually increased. The ion concentration of the electrolyte inside the electrode body eventually exceeds a favorable level, so that, in this case, too, the apparent battery capacity is reduced because of reduced battery reaction.

Conventional secondary batteries had this problem of apparent battery capacity being reduced when the battery is repeatedly discharged or charged at a high rate in low temperature environments.

To address this problem, in Patent Document 1, a wound electrode body is configured to hold more electrolyte per unit area in a central part in the axial direction than at both ends in a winding core portion of the electrode body where active material layers of positive and negative electrode plates overlap with each other with the separator interposed therebetween. More specifically, the positive and negative active material layers and the separator have higher porosity in the central part than at both ends in the axial direction so that the wound electrode body holds more electrolyte in the center than at both ends in the axial direction. Also, the separator has a larger thickness in the central part than at both ends in the axial direction so that the wound electrode body holds more electrolyte in the center than at both ends in the axial direction.

More electrolyte can be held in the center than at both ends of the winding core portion by these methods. Changes in the ion concentration of electrolyte in the central part of the winding core portion can be made smaller by increasing the amount of electrolyte held in the central part, so that a decrease in the apparent battery capacity due to increased internal resistance is prevented when the battery is repeatedly discharged or charged at a high rate in low temperature environments.

### RELATED ART DOCUMENTS

### Patent Documents

Patent Document 1: JP2009-211956A

### SUMMARY OF INVENTION

### Problems to be Solved by the Invention

Even in the secondary battery of the above described Patent Document 1, electrolyte with higher ion concentration is still pushed out of the wound electrode body when the battery is discharged at a high rate in low temperature environments. Also, electrolyte with lower ion concentration is pushed out of the wound electrode body when the battery is charged at a high rate in low temperature environments. Therefore, when the battery is repeatedly discharged or charged in this manner, as mentioned above, the ion concentration of electrolyte inside the electrode body changes gradually and the internal resistance increases as a result of which the apparent capacity of the battery is gradually reduced.

The present invention has been made in view of such circumstances, its object being to provide a secondary battery capable of preventing a decrease in the apparent capacity caused by repeated high-rate discharge or charge in low temperature environments. Another object is to provide a method of manufacturing this secondary battery.

### Means of Solving the Problems

To solve the above problem, one aspect of the present invention is to provide a secondary battery including: a wound electrode body formed by winding an elongated positive electrode plate and an elongated negative electrode plate overlapped upon one another via an elongated separator interposed therebetween around an axis; and electrolyte contained inside the wound electrode body, wherein the wound electrode body includes a fluid flow restrictor for restricting flow of the electrolyte between inside and outside of the wound electrode body in an axial direction along the axis, when a portion where the separator exists in a radial direction of the axis of the wound electrode body is defined as an electrode body central part, the fluid flow restrictor is at least one of: a one side fluid flow restrictor formed in one axial end portion of one axial end side of the electrode body central part to restrict flow of the electrolyte through the one axial end portion; and the other side fluid flow restrictor formed in the other axial end portion of the other axial end side of the electrode body central part to restrict flow of the electrolyte through the other axial end portion, and the one side fluid flow restrictor and the other side fluid flow restrictor are both formed of a gel-like substance containing the electrolyte and being in a form of a gel.

In this secondary battery, the wound electrode body is provided with the fluid flow restrictor restricting flow of the electrolyte between inside and outside (outside in an axial direction) of the wound electrode body. This fluid flow restrictor can prevent the electrolyte with high or low ion concentration from being pushed out of the wound electrode body when the battery is discharged or charged at a high rate in low temperature environments, so that a gradual change of the ion concentration of the electrolyte inside the wound electrode body caused by repeated discharge or charge is prevented. Accordingly, a decrease in the apparent battery capacity due to increased internal resistance is prevented even when the battery is repeatedly discharged or charged at a high rate in low temperature environments.

Further, in this secondary battery, the one side fluid flow restrictor is formed in the one axial end portion of the electrode body central part where the separator exists in the radial direction of the axis to restrict flow of the electrolyte through this portion between inside and outside of the electrode body central part, and the other side fluid flow restrictor is formed in the other axial end portion of the electrode body central part to restrict flow of the electrolyte through this portion between inside and outside of the electrode body central part.

With these fluid flow restrictors on one and the other sides, a gradual change of the ion concentration of electrolyte inside the “electrode body central part” of the wound electrode body caused by repeated discharge or charge can be prevented more effectively than by providing fluid flow restrictors at, for example, both ends of the wound electrode body. Since the “electrode body central part” contains a part where the battery reaction occurs, a decrease in the apparent battery capacity due to increased internal resistance can be prevented more effectively by effectively preventing changes in the ion concentration in this “electrode body central part”.

The “one side fluid flow restrictor” is formed in the one axial end portion of the electrode body central part as mentioned above. The one side fluid flow restrictor may be formed in a configuration, for example, to close the entire path through which the electrolyte can flow via the one axial end portion. Alternatively, the one side fluid flow restrictor on one side may be formed to close a part of the path.

The “other side fluid flow restrictor” is formed in the other axial end portion of the electrode body central part as mentioned above. The other side fluid flow restrictor may be formed in a configuration, for example, to close the entire path through which the electrolyte can flow via the other axial end portion. Alternatively, the other side fluid flow restrictor may be formed to close a part of the path.

Further, in this secondary battery, the one side fluid flow restrictor and the other side fluid flow restrictor are formed of a gel-like substance containing the electrolyte and being in the form of a gel, and the presence of this gel-like substance makes it hard for the electrolyte to flow. Therefore, the electrolyte is effectively prevented from being pushed out of the electrode body central part when the battery is discharged or charged at a high rate in low temperature environments. Accordingly, in this secondary battery, a gradual change of ion concentration of the electrolyte inside the electrode body central part is prevented even when high-rate discharge or charge is repeated in low temperature environments, and therefore a decrease in the apparent battery capacity due to increased internal resistance is effectively prevented.

Examples of the “gel-like substance” include polyvinylidene fluoride (PVDF), or polyvinylidene fluoride-co-hexafluoropropylene (P(VDF-HFP)), that has absorbed the electrolyte and turned into a gel.

In the secondary battery described above, preferably, the positive electrode plate is formed by an elongated positive current collecting foil and a positive active material layer formed on a part of the foil, the positive electrode plate including: a strip-shaped positive electrode portion, extending in a longitudinal direction of the positive electrode plate, where the positive active material layer is present in a thickness direction of the positive electrode portion; and a strip-shaped positive current collecting portion, located at one end in a width direction of the positive current collecting foil and formed extending in the longitudinal direction, where the positive active material layer is not present in a thickness direction of the positive current collecting portion, the negative electrode plate is formed by an elongated negative current collecting foil and a negative active material layer formed in a part of the foil, the negative electrode plate including: a strip-shaped negative electrode portion, extending in a longitudinal direction of the negative electrode plate, where the negative active material layer is present in a thickness direction of the negative electrode portion; and a strip-shaped negative current collecting portion, located at one end in a width direction of the negative current collecting foil and formed extending in the longitudinal direction, where the negative active material layer is not present in the thickness direction of the negative current collecting portion, the wound electrode body is configured such that a part of the positive current collecting portion protrudes in a spiral shape from the electrode body central part toward the one axial end side, and a part of the negative current collecting portion protrudes in a spiral shape from the electrode body central part toward the other axial end side, the one side fluid flow restrictor is at least one of: a first restrictor formed in pores in an end portion of the one axial end side of the positive active material layer having a porous structure; a second restrictor formed between an inner positive collector portion of the positive current collecting portion located inside the electrode body central part and a positive electrode facing portion of the separator facing the inner positive collector portion; a third restrictor formed in pores in an end portion of the one axial end side of the negative active material layer having a porous structure; and a fourth restrictor formed between one end facing parts of the separators located at the one axial end side and directly facing each other, and the other side fluid flow restrictor is at least one of: a fifth restrictor formed in pores in an end portion of the other axial end side of the negative active material layer having a porous structure; a sixth restrictor formed between an inner negative collector portion of the negative current collecting portion located inside the electrode body central part and a negative electrode facing portion of the separator facing the inner negative collector portion; a seventh restrictor formed in pores in an end portion of the other axial end side of the positive active material layer having a porous structure; and an eighth restrictor formed between the other end facing parts of the separators located at the other axial end side and directly facing each other.

In this secondary battery, the one side fluid flow restrictor is at least one of the first restrictor to the fourth restrictor. Of these, the first restrictor, if provided, can prevent the electrolyte from being pushed out of the electrode body central part through the pores of the positive active material layer in the one axial end portion when the battery is discharged or charged at a high rate in low temperature environments. The second restrictor, if provided, can prevent the electrolyte from being pushed out of the electrode body central part through between the positive current collecting portion (inner collector portion) and the separator (positive electrode facing portion) when the battery is discharged or charged at a high rate in low temperature environments. The third restrictor, if provided, can prevent the electrolyte from being pushed out of the electrode body central part through the pores of the negative active material layer in the one axial end portion when the battery is discharged or charged at a high rate in low temperature environments. The fourth restrictor, if provided, can prevent the electrolyte from being pushed out of the electrode body central part through between the separators (one end facing parts) when the battery is discharged or charged at a high rate in low temperature environments.

In this secondary battery, the other side fluid flow restrictor is at least one of the fifth restrictor to the eighth restrictor. Of these, the fifth restrictor, if provided, can prevent the electrolyte from being pushed out of the electrode body central part through the pores of the negative active material layer in the other axial end portion when the battery is discharged or charged at a high rate in low temperature environments. The sixth restrictor, if provided, can prevent the electrolyte from being pushed out of the electrode body central part through between the negative current collecting portion (inner collector portion) and the separator (negative electrode facing portion) when the battery is discharged or charged at a high rate in low temperature environments. The seventh restrictor, if provided, can prevent the electrolyte from being pushed out of the electrode body central part through the pores of the positive active material layer in the other axial end portion when the battery is discharged or charged at a high rate in low temperature environments. The eighth restrictor, if provided, can prevent the electrolyte from being pushed out of the electrode body central part through between the separators (the other end facing parts) when the battery is discharged or charged at a high rate in low temperature environments.

Accordingly, in this secondary battery, a gradual change of lithium ion concentration of the electrolyte inside the electrode body central part is prevented even when high-rate discharge or charge is repeated in low temperature environments, and therefore a decrease in the apparent battery capacity due to increased internal resistance is prevented.

Any of the secondary batteries described above is preferably a secondary battery for use as a vehicle drive power source mounted on a vehicle and used as the drive power source of the vehicle.

This secondary battery is capable of preventing a decrease in the apparent battery capacity when it is repeatedly discharged or charged at a high rate in low temperature environments as described above. Accordingly, the performance of the vehicle on which this secondary battery is mounted can be maintained high over a long period of time.

Examples of the “vehicle” include, for example, electric vehicles, hybrid electric vehicles, plug-in hybrid electric vehicles, hybrid railway vehicles, forklifts, electric wheelchairs, electric assist bicycles, electric motor scooters, and the like.

Any of the secondary batteries described above may preferably be a secondary battery for use in battery powered equipment mounted in and used as the power source of battery powered equipment.

This secondary battery is capable of preventing a decrease in the apparent battery capacity when it is repeatedly discharged or charged at a high rate in low temperature environments as described above. Accordingly, the performance of the battery powered equipment in which this secondary battery is mounted can be maintained high over a long period of time.

Examples of “battery powered equipment” include, for example, various battery-driven domestic and office appliances and industrial equipment, such as personal computers, mobile phones, battery-driven electric tools, uninterruptible power sources, and the like.

Another aspect of the invention resides in a method for manufacturing a secondary battery including: a wound electrode body formed by winding an elongated positive electrode plate and an elongated negative electrode plate overlapped upon one another via an elongated separator interposed therebetween around an axis; and electrolyte contained inside the wound electrode body, the wound electrode body including a fluid flow restrictor for restricting flow of the electrolyte between inside and outside of the wound electrode body in an axial direction along the axis, when a portion where the separator exists in a radial direction of the axis of the wound electrode body is defined as the electrode body central part, the fluid flow restrictor is at least one of: a one side fluid flow restrictor formed in one axial end portion of one axial end side of the electrode body central part to restrict flow of the electrolyte through the one axial end portion; and the other fluid flow restrictor formed in the other axial end portion of the other axial end side of the electrode body central part to restrict flow of the electrolyte through the other axial end portion, and the pre-processed one side fluid flow restrictor and the pre-processed the other side fluid flow restrictor are both formed of a gelling material that absorbs the electrolyte and turns into a gel when subjected to a heating process that is the flow restricting process, wherein the method includes: a pre-processed restrictor formation step of forming a pre-processed fluid flow restrictor which is to be subjected to a predetermined flow restricting process to reduce flowability of the electrolyte through the restrictor in the wound electrode body; an electrolyte injecting step of injecting the electrolyte into the wound electrode body through the pre-processed fluid flow restrictor after the pre-processed restrictor formation step; and a restrictor formation step of performing the flow restricting process after the electrolyte injecting step to turn the pre-processed fluid flow restrictor into the fluid flow restrictor, the pre-processed restrictor formation step includes at least one of: a step of forming a pre-processed one side fluid flow restrictor that is the pre-processed fluid flow restrictor, formed in the one axial end portion of the one axial end side of the electrode body central part; and a step of forming a pre-processed the other side fluid flow restrictor that is the pre-processed fluid flow restrictor, formed in the other axial end portion of the other axial end side of the electrode body central part, the electrolyte injecting step is a step of injecting the electrolyte into the electrode body central part through at least one of the pre-processed one side fluid flow restrictor and the pre-processed the other side fluid flow restrictor, and the restrictor formation step includes at least one of: a step of turning the pre-processed one side fluid flow restrictor into the one side fluid flow restrictor; and a step of turning the pre-processed the other fluid flow restrictor into the other side fluid flow restrictor, and the restrictor formation step is a step of performing the heating process as the flow restricting process.

With this method of manufacturing a secondary battery, a pre-processed fluid flow restrictor, which is to be subjected to a predetermined flow restricting process to reduce flowability of the electrolyte through the restrictor, is formed in the wound electrode body beforehand (pre-processed restrictor formation step). After the electrolyte is injected into the wound electrode body through this pre-processed fluid flow restrictor (electrolyte injecting step), the predetermined flow restricting process is performed to turn the pre-processed fluid flow restrictor into the fluid flow restrictor (restrictor formation step). When the electrolyte is injected into the wound electrode body, the flowability of electrolyte through the pre-processed fluid flow restrictor has not been reduced yet, so that the electrolyte can be injected into the wound electrode body through the restrictor. The fluid flow restrictor is formed easily, as the pre-processed fluid flow restrictor is turned into the fluid flow restrictor by performing the predetermined flow restricting process after the electrolyte has been injected into the wound electrode body.

Thus, the secondary battery manufactured by this method can, while allowing injection of electrolyte into the wound electrode body, prevent the electrolyte from being pushed out of the wound electrode body after the flow restricting process. Accordingly, a secondary battery capable of preventing electrolyte with higher or lower ion concentration from being pushed out of the wound electrode body when it is discharged or charged at a high rate in low temperature environments can be manufactured easily.

The “pre-processed fluid flow restrictor” may be formed of a gelling material such as polyvinylidene fluoride (PVDF), or polyvinylidene fluoride-co-hexafluoropropylene (P(VDF-HFP)), that absorbs the electrolyte and turns into a gel when subjected to a heating or gelling process or the like.

Further, this secondary battery manufacturing method includes the pre-processed restrictor formation step, the electrolyte injecting step, and the restrictor formation step. When the electrolyte is injected into the electrode body central part, the flowability of electrolyte through the pre-processed one side fluid flow restrictor and the preprocessed the other side fluid flow restrictor has not been reduced yet, so that the electrolyte can be injected into the wound electrode body through the restrictors. The one side fluid flow restrictor and the other side fluid flow restrictor are formed easily, as the pre-processed one side fluid flow restrictor and the pre-processed the other side fluid flow restrictor are turned into the one side fluid flow restrictor and the other side fluid flow restrictor, respectively, by performing the predetermined flow restricting process after the electrolyte has been injected into the electrode body central part.

Thus, the secondary battery manufactured by this method can, while allowing injection of electrolyte into the electrode body central part, prevent the electrolyte from being pushed out of the electrode body central part after the flow restricting process. Accordingly, a secondary battery capable of preventing electrolyte with higher or lower ion concentration from being pushed out of the electrode body central part when it is discharged or charged at a high rate in low temperature environments can be manufactured easily.

Further, with this secondary battery manufacturing method, the one side fluid flow restrictor and the other side fluid flow restrictor are formed easily, as the pre-processed one side fluid flow restrictor and the pre-processed the other side fluid flow restrictor are both formed of a gelling material that absorbs the electrolyte and turns into a gel when subjected to a heating process, and turned into the one side fluid flow restrictor and the other side fluid flow restrictor by performing the heating process.

In the secondary battery manufactured by this method, the one side fluid flow restrictor and the other side fluid flow restrictor are formed of a gel-like substance containing the electrolyte and being in the form of a gel, and the presence of this gel-like substance makes it hard for the electrolyte to flow. Therefore, the electrolyte is effectively prevented from being pushed out of the electrode body central part when the battery is discharged or charged at a high rate in low temperature environments. Accordingly, in this secondary battery, a gradual change of ion concentration of the electrolyte inside the electrode body central part is prevented even when high-rate discharge or charge is repeated in low temperature environments, and therefore a decrease in the apparent battery capacity due to increased internal resistance is effectively prevented.

In the secondary battery manufacturing method described above, preferably, the positive electrode plate is formed by an elongated positive current collecting foil and a positive active material layer formed in a part of the foil, the positive electrode plate including: a strip-shaped positive electrode portion, extending in a longitudinal direction, where the positive active material layer is present in a thickness direction of the positive electrode portion; and a strip-shaped positive current collecting portion, located at one end in a width direction of the positive current collecting foil and formed extending in the longitudinal direction, where the positive active material layer is not present in a thickness direction of the positive current collecting portion, the negative electrode plate is formed by an elongated negative current collecting foil and a negative active material layer formed in a part of the foil, the negative electrode plate including: a strip-shaped negative electrode portion, extending in a longitudinal direction, where the negative active material layer is present in a thickness direction of the negative electrode plate, and a strip-shaped negative current collecting portion, located at one end in a width direction of the negative current collecting foil and formed extending in the longitudinal direction, where the negative active material layer is not present in a thickness direction of the negative electrode plate, the wound electrode body is configured such that: a part of the positive current collecting portion protrudes in a spiral shape from the electrode body central part toward the one axial end side, and a part of the negative current collecting portion protrudes in a spiral shape from the electrode body central part toward the other axial end side, the pre-processed restrictor formation step includes at least one of: a first formation step of forming the pre-processed one side fluid flow restrictor in pores in an end portion of the one axial end side of the positive active material layer having a porous structure; a second formation step of forming the pre-processed one side fluid flow restrictor between an inner positive collector portion of the positive current collecting portion located inside the electrode body central part and a positive electrode facing portion of the separator facing the inner positive collector portion; a third formation step of forming the pre-processed one side fluid flow restrictor in pores in an end portion of the one axial end side of the negative active material layer having a porous structure; a fourth formation step of forming the pre-processed one side fluid flow restrictor between one end facing parts of the separators located at one axial end and directly facing each other; a fifth formation step of forming the pre-processed the other side fluid flow restrictor in pores in an end portion of the other axial end side of the negative active material layer having a porous structure; a sixth formation step of forming the pre-processed the other side fluid flow restrictor between an inner negative collector portion of the negative current collecting portion located inside the electrode body central part and a negative electrode facing portion of the separator facing the inner negative collector portion; a seventh formation step of forming the pre-processed the other side fluid flow restrictor in pores in an end portion of the other axial end side of the positive active material layer having a porous structure; and an eighth formation step of forming the pre-processed the other side fluid flow restrictor between the other end facing parts of the separator located at the other axial end and directly facing each other.

In this secondary battery manufacturing method, the pre-processed restrictor formation step includes at least one of the above first formation step to the eighth formation step. Of these, in the first formation step, the pre-processed one side fluid flow restrictor is formed in pores of the positive active material layer in one axial end portion thereof, so that, after the flow restricting process, the electrolyte is prevented from being pushed out of the electrode body central part through the pores.

In the second formation step, the pre-processed one side fluid flow restrictor is formed in a strip-like shape extending in the longitudinal direction of the positive electrode plate and the separator, the restrictor being formed between the inner collector portion of the positive current collecting portion and the positive electrode facing portion of the separator, so that, after the flow restricting process, the electrolyte is prevented from being pushed out of the electrode body central part through between the positive current collecting portion (inner collector portion) and the separator (positive electrode facing portion).

In the third formation step, the pre-processed one side fluid flow restrictor is formed in pores of the negative active material layer in one axial end portion thereof, so that, after the flow restricting process, the electrolyte is prevented from being pushed out of the electrode body central part through the pores.

In the fourth formation step, the pre-processed one side fluid flow restrictor is formed in a strip-like shape extending in the longitudinal direction of the separator, the restrictor being formed between the one end facing parts of the separator, so that, after the flow restricting process, the electrolyte is prevented from being pushed out of the electrode body central part through between the separators (one end facing parts).

In the fifth formation step, the pre-processed the other side fluid flow restrictor is formed in pores of the negative active material layer in the other axial end portion thereof, so that, after the flow restricting process, the electrolyte is prevented from being pushed out of the electrode body central part through the pores.

In the sixth formation step, the pre-processed the other side fluid flow restrictor is formed in a strip-like shape extending in the longitudinal direction of the negative electrode plate and the separator, the restrictor being formed between the inner collector portion of the negative current collecting portion and the negative electrode facing portion of the separator, so that, after the flow restricting process, the electrolyte is prevented from being pushed out of the electrode body central part through between the negative current collecting portion (inner collector portion) and the separator (negative electrode facing portion).

In the seventh formation step, the pre-processed the other side fluid flow restrictor is formed in pores of the positive active material layer in the other axial end portion thereof, so that, after the flow restricting process, the electrolyte is prevented from being pushed out of the electrode body central part through the pores.

In the eighth formation step, the pre-processed the other side fluid flow restrictor is formed in a strip-like shape extending in the longitudinal direction of the separator, the restrictor being formed between the other end facing parts of the separator, so that, after the flow restricting process, the electrolyte is prevented from being pushed out of the electrode body central part through between the separators (the other end facing parts).

Accordingly, the secondary battery manufactured by this method can prevent a gradual change of ion concentration of the electrolyte inside the electrode body central part even when it is repeatedly discharged or charged at a high rate in low temperature environments, and can prevent an increase in the internal resistance and a consequent decrease in the apparent capacity.

### BRIEF DESCRIPTION OF THE DRAWINGS

FIG. 1 is a vertical sectional view of a lithium ion secondary battery according to Embodiment 1;

FIG. 2 is a perspective view of a wound electrode body in Embodiment 1;

FIG. 3 is a plan view of a positive electrode plate in Embodiment 1;

FIG. 4 is a sectional view of the positive electrode plate taken along a line A-A in FIG. 3 in Embodiment 1;

FIG. 5 is a plan view of a negative electrode plate in Embodiment 1;

FIG. 6 is a sectional view of the negative electrode plate taken along a line B-B in FIG. 5 in Embodiment 1;

FIG. 7 is a plan view of a separator in Embodiment 1;

FIG. 8 is a sectional view of the separator taken along a line C-C in FIG. 7 in Embodiment 1;

FIG. 9 is a partial plan view showing a state that the positive electrode plate and the negative electrode plate are overlapped upon one another with the separator interposed therebetween in Embodiment 1;

FIG. 10 is a sectional view taken along a line D-D in FIG. 9 showing the state that the positive electrode plate and the negative electrode plate are overlapped upon one another with the separator interposed therebetween in Embodiment 1;

FIG. 11 is a partial sectional view of the wound electrode body in Embodiment 1;

FIG. 12 is an exploded perspective view of a case lid member, a positive terminal member, and a negative terminal member and others in Embodiment 1;

FIG. 13 is a plan view of a positive electrode plate in a reference embodiment:

FIG. 14 is a sectional view of the positive electrode plate taken along a line E-E in FIG. 13 in the reference embodiment;

FIG. 15 is a plan view of a negative electrode plate in the reference embodiment;

FIG. 16 is a sectional view of the negative electrode plate taken along a line F-F in FIG. 15 in the reference embodiment;

FIG. 17 is a plan view of a separator in the reference embodiment;

FIG. 18 is a sectional view of the separator taken along a line G-G in FIG. 17 in the reference embodiment;

FIG. 19 is a partial plan view showing a state that the positive electrode plate and the negative electrode plate are overlapped upon one another via the separator interposed therebetween in the reference embodiment;

FIG. 20 is a sectional view taken along a line H-H in FIG. 19 showing the state that the positive electrode plate and the negative electrode plate are overlapped upon one another via the separator interposed therebetween in the reference embodiment;

FIG. 21 is a partial sectional view of the wound electrode body in the reference embodiment;

FIG. 22 is an explanatory view showing a vehicle in Embodiment 3; and

FIG. 23 is an explanatory view showing a hammer drill in Embodiment 4.

### REFERENCE SIGNS LIST

100, 200 Lithium ion secondary battery (nonaqueous electrolyte secondary battery)
120, 220 Wound electrode body
120f, 220f Electrode body central part
120fa, 220fa One axial end portion (of the electrode body central part)
120fb, 220fb The other axial end portion (of the electrode body central part)
121, 221 Positive electrode plate
121w, 221w Positive electrode portion
121m, 221m Positive electrode collecting portion
121m1, 221m1 Inner collector portion of the positive electrode collecting portion
121m2, 221m2 Outer collector portion of the positive electrode collecting portion
122 Positive current collecting foil
123 Positive active material layer
123a One axial end portion (of the positive active material layer)
123b The other axial end portion (of the positive active material layer)
131, 231 Negative electrode plate
131w, 231w Negative electrode portion
131m, 231m Negative electrode collecting portion
131m1, 231m1 Inner collector portion of the negative electrode collecting portion
131m2, 231m2 Outer collector portion of the negative electrode collecting portion
132 Negative current collecting foil
133 Negative active material layer
133a One axial end portion (of the negative active material layer)
133b The other axial end portion (of the negative active material layer)
141, 241 Separator
141a, 241a Positive electrode facing portion
141b, 241b Negative electrode facing portion
141c, 241c One end facing part
141d, 241d The other end facing part
190, 290 One side fluid flow restrictor (fluid flow restrictor)
190x Pre-processed one side fluid flow restrictor
191 First restrictor
191x Pre-processed first restrictor
192, 292 Second restrictor
192x Pre-processed second restrictor
193 Third restrictor
193x Pre-processed third restrictor
194, 294 Fourth restrictor
194x Pre-processed fourth restrictor
195, 295 The other side fluid flow restrictor (fluid flow restrictor)
195x Pre-processed the other side fluid flow restrictor (pre-processed fluid flow restrictor)
196 Fifth restrictor
196x Pre-processed fifth restrictor
197, 297 Sixth restrictor
197x Pre-processed sixth restrictor
198 Seventh restrictor
198x Pre-processed seventh restrictor
199, 299 Eighth restrictor
199x Pre-processed eighth restrictor
700 Vehicle
800 Hammer drill
AX Axis
SA One axial end
SB The other axial end

### MODE FOR CARRYING OUT THE INVENTION

### Embodiment 1

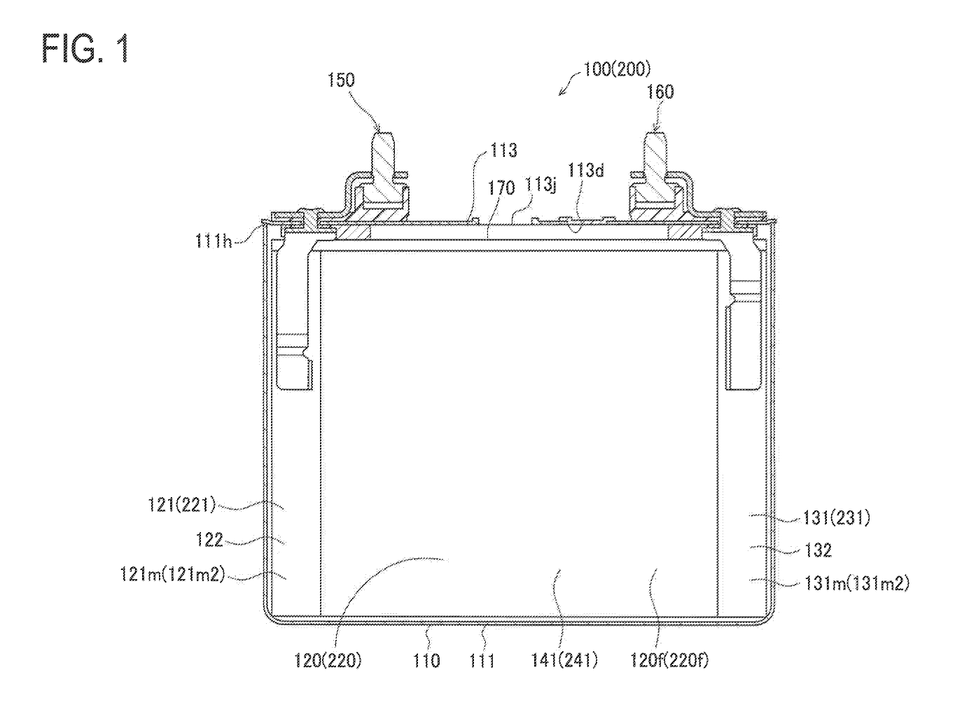

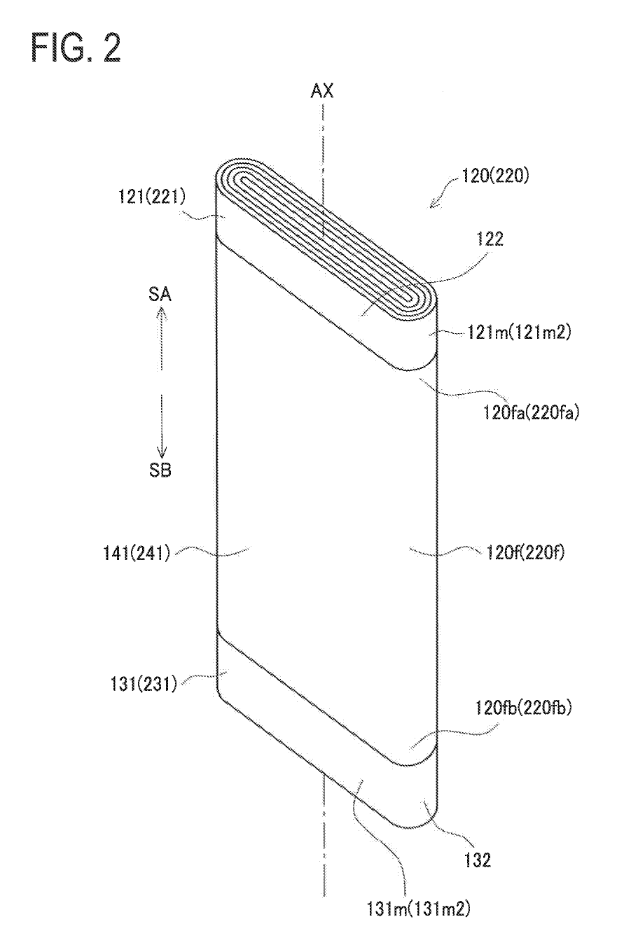

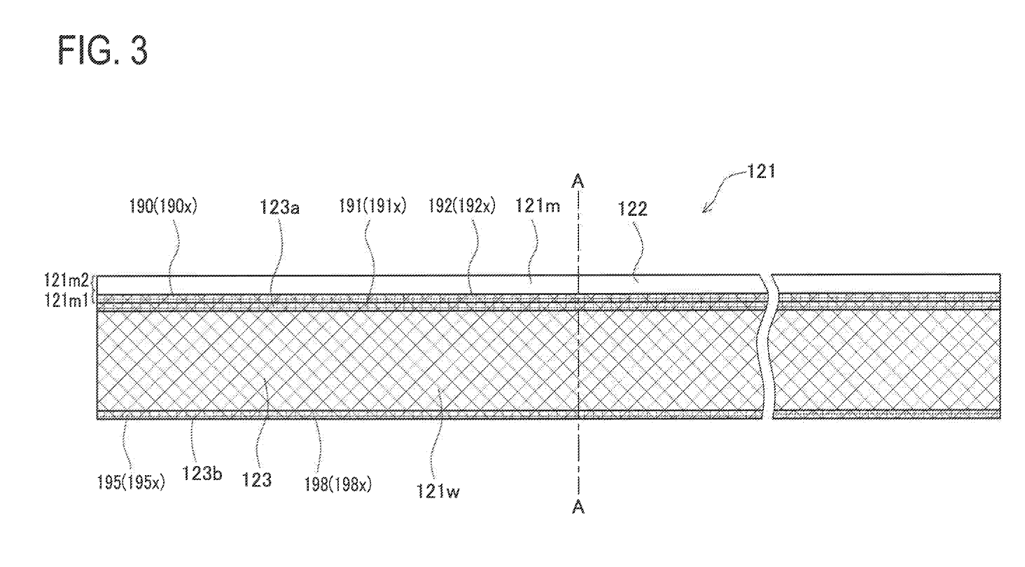

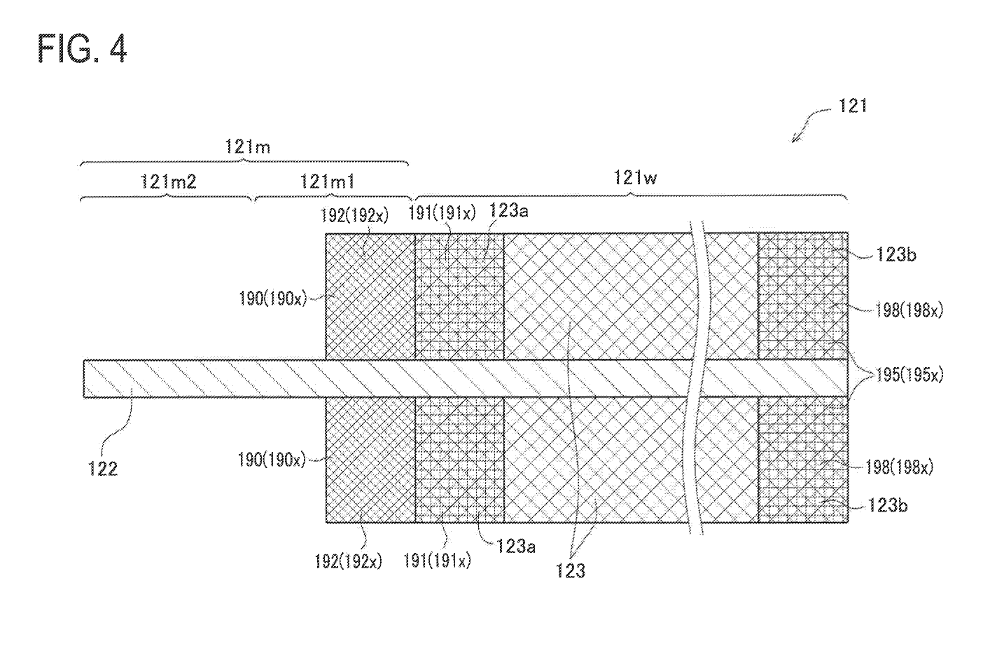

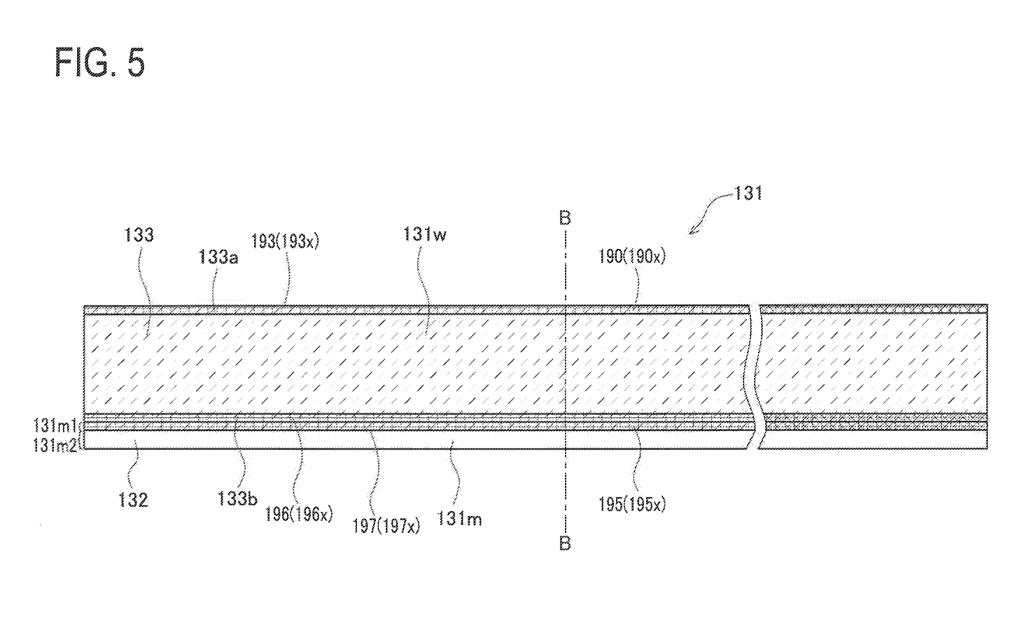

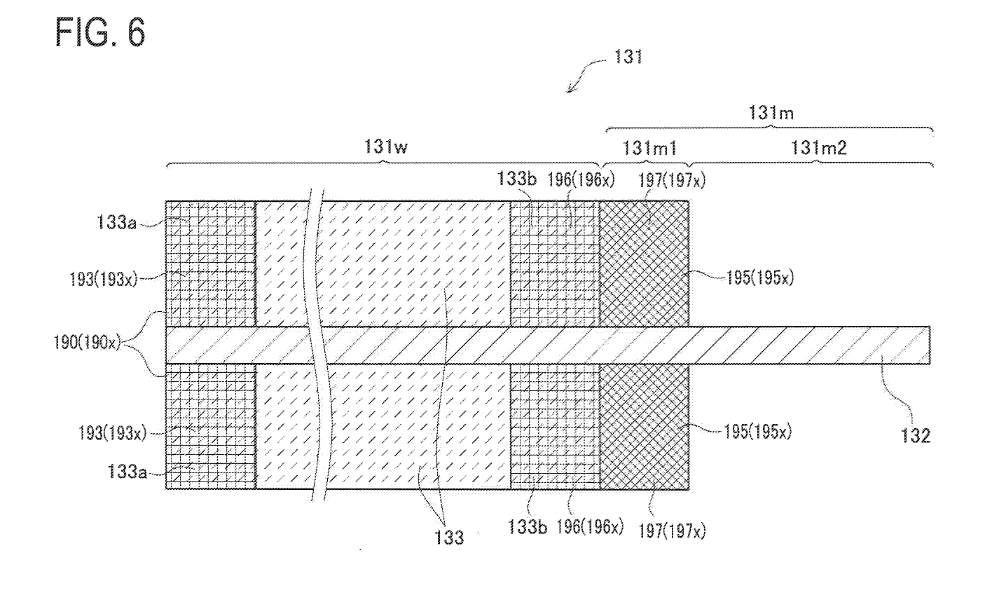

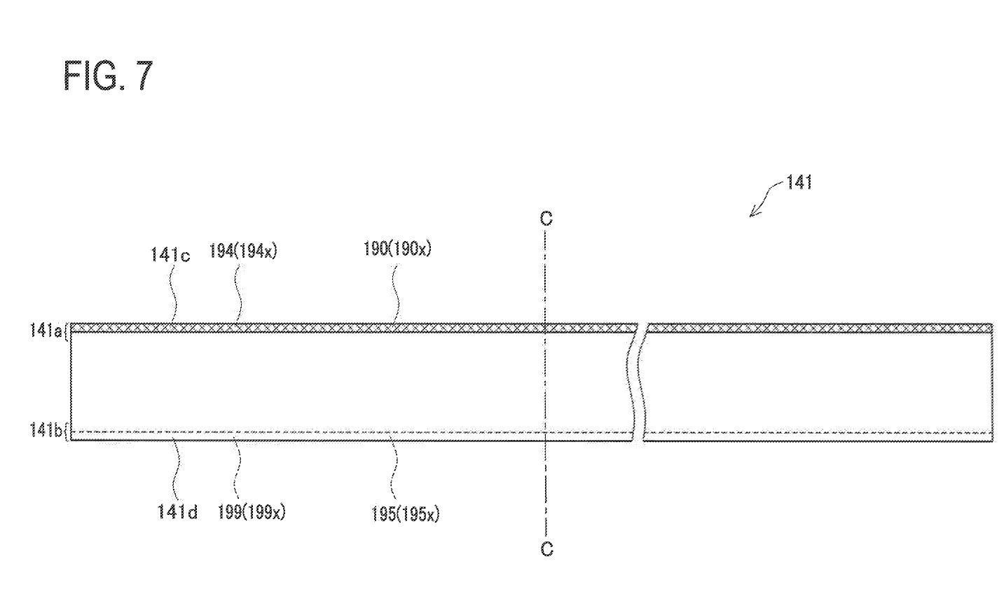

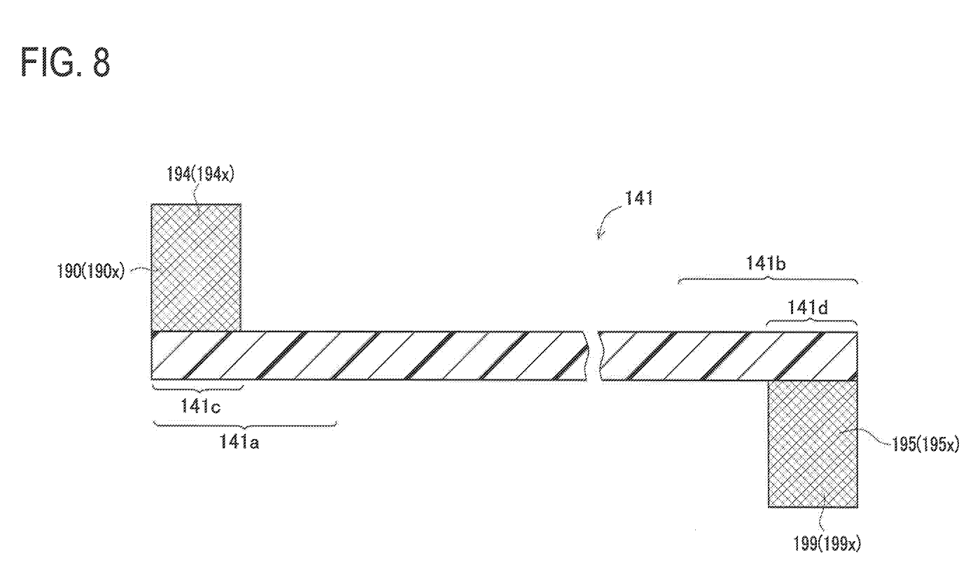

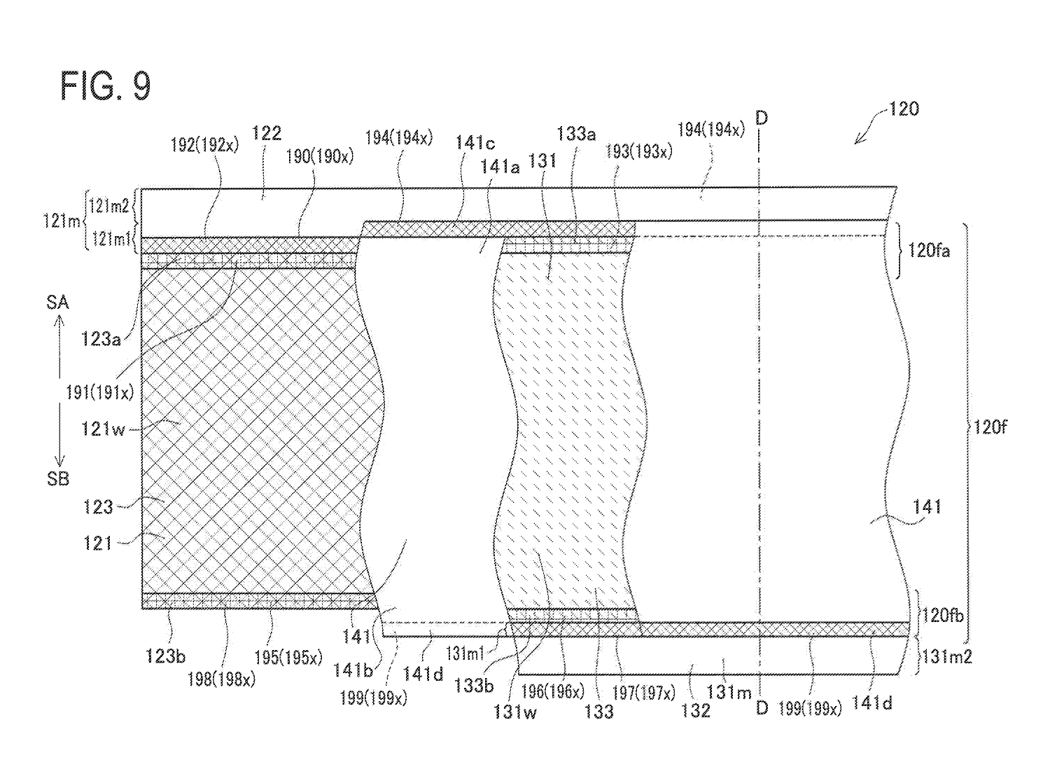

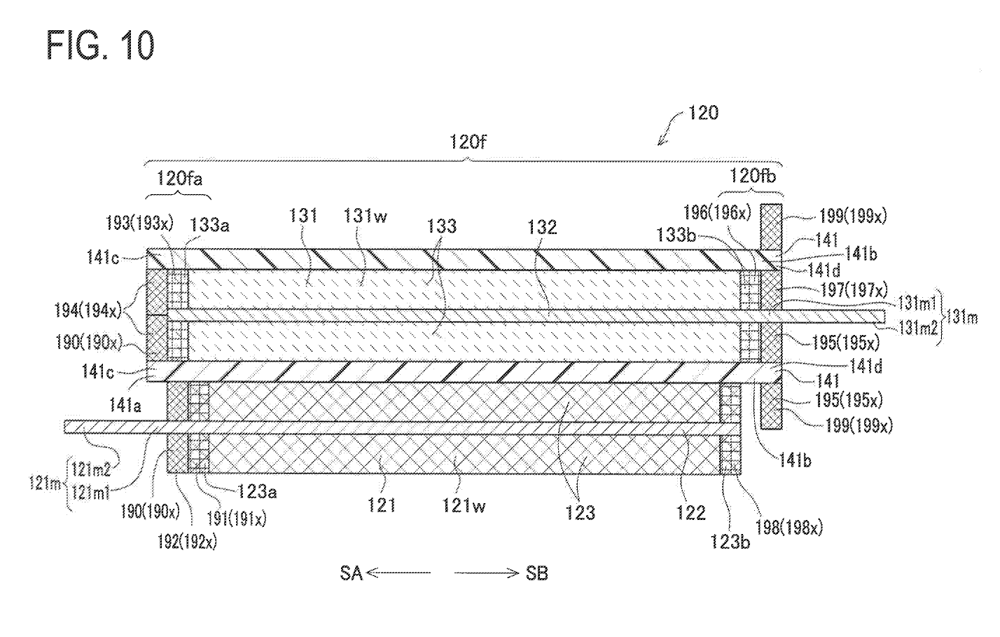

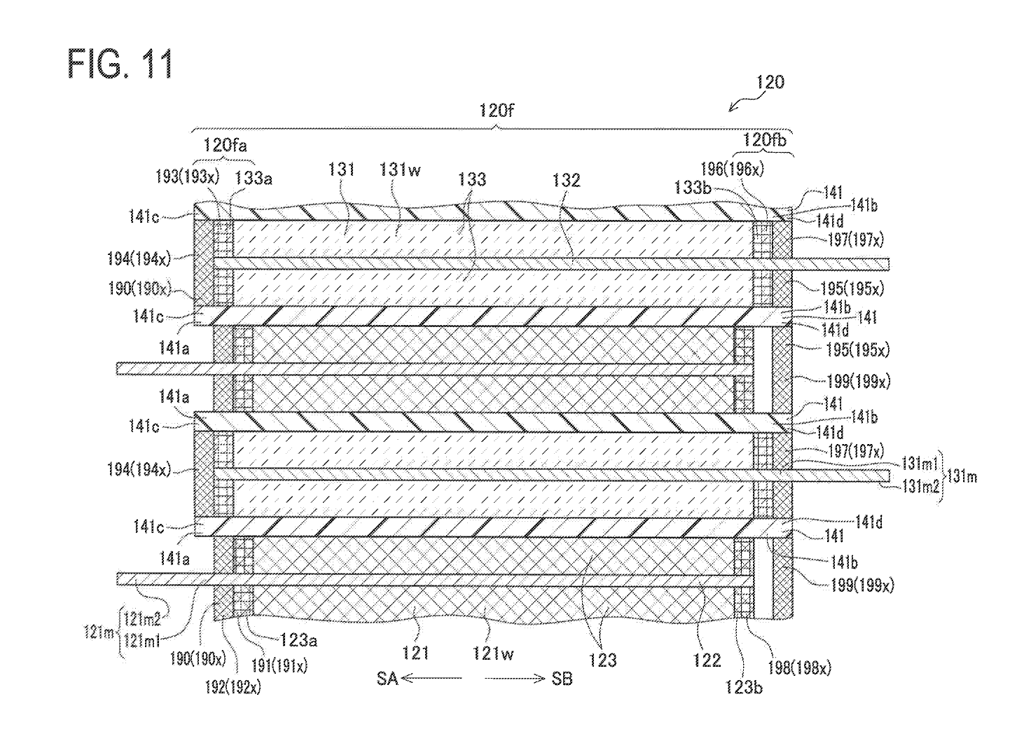

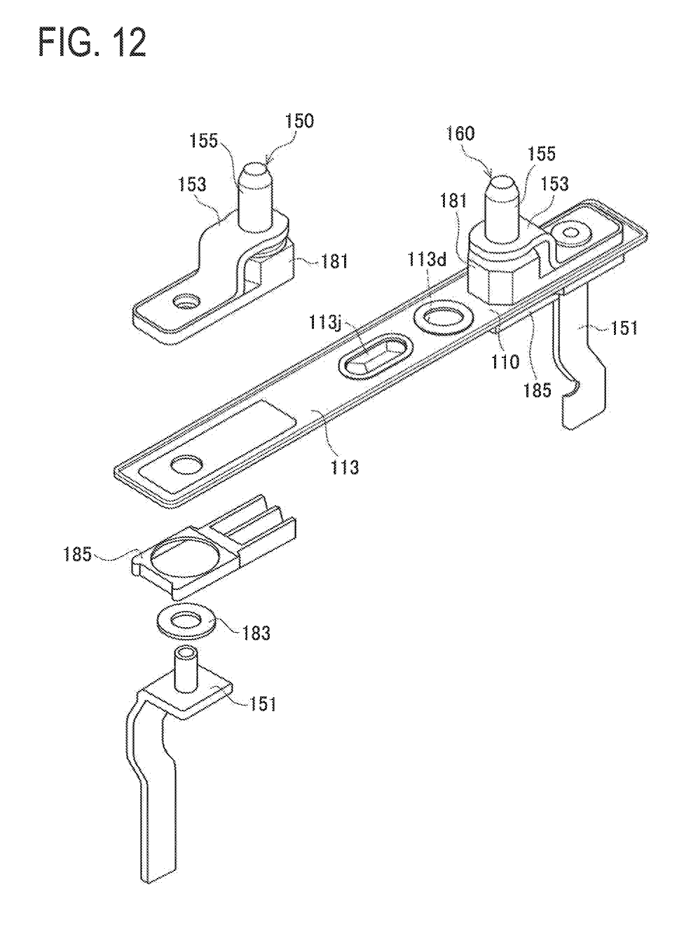

Hereinafter, embodiments of the present invention will be described with reference to the drawings. FIG. 1 illustrates a lithium ion secondary battery (secondary battery) 100 according to Embodiment 1. FIG. 2 and FIG. 11 illustrate a wound electrode body 120 forming this lithium ion secondary battery 100. Further, a positive electrode plate 121 forming this wound electrode body 120 is illustrated in FIGS. 3 and 4, a negative electrode plate 131 is illustrated in FIGS. 5 and 6, and a separator 141 is illustrated in FIGS. 7 and 8. FIGS. 9 and 10 illustrate the positive electrode plate 121 and the negative electrode plate 131 overlapped upon one another via the separator 141 interposed therebetween. FIG. 12 illustrates the details of a case lid member 113, a positive terminal member 150, and a negative terminal member 160, etc.

This lithium ion secondary battery 100 is a prismatic battery mounted on vehicles such as hybrid electric vehicles and electric vehicles, or battery powered equipment such as a hummer drill. This lithium ion secondary battery 100 is formed by a prismatic battery case 110, the wound electrode body 120 accommodated in this battery case 110, and the positive and negative terminal members 150 and 160, etc supported in the battery case 110 (see FIG. 1). Not-shown electrolyte is injected into the battery case 110.

Of these, the battery case 110 is formed by a box-like case body 111 having an opening only at the top, and the rectangular plate-like case lid member 113 welded to this case body 111 such as to close an opening 111h thereof. The case lid member 113 is provided with a safety valve 113j that breaks when the internal pressure of the battery case 110 reaches a predetermined level (see FIGS. 1 and 12). The case lid member 113 is also provided with an electrolyte inlet port 113d for pouring the electrolyte into the battery case 110.

To the case lid member 113 are fixedly attached the positive and negative terminal members 150 and 160 via three insulating members 181, 183, and 185 each. These positive and negative terminal members 150 and 160 are each formed by three metal terminal fittings 151, 153, and 155. The positive terminal member 150 is connected to a positive current collecting portion 121m (outer collector portion 121m2) of the positive electrode plate 121 of the wound electrode body 120, while the negative terminal member 160 is connected to a negative current collecting portion 131m (outer collector portion 131m2) of the negative electrode plate 131 of the wound electrode body 120 inside the battery case 110.

Next, the wound electrode body 120 will be described. This wound electrode body 120 is encased in an insulating film envelop 170 made of a bag-shaped insulating film with an opening only at the top and accommodated in the battery case 110, placed horizontally on its side (see FIG. 1). This wound electrode body 120 is formed by winding the elongated positive electrode plate 121 (see FIGS. 3 and 4) and the elongated negative electrode plate 131 (see FIGS. 5 and 6) overlapped upon one another via the elongated air permeable separator 141 (see FIGS. 7 and 8) around an axis AX and by compressing these into a flat shape (see FIGS. 9 to 11, and FIG. 2).

The wound electrode body 120 includes an electrode body central part 120f in the center in an axis AX, which is a part where the separator 141 exists in a radial direction of the axis AX. A part of the positive current collecting portion 121m (outer collector portion 121m2) in a width direction, to be described later, of the positive electrode plate 121 protrudes in a spiral shape from this electrode body central part 120f toward one axial end SA (left side in FIGS. 1 and 11, upper side in FIG. 2). On the other hand, a part of the negative current collecting portion 131m (outer collector portion 131m2) in the width direction, to be described later, of the negative electrode plate 131 protrudes in a spiral shape from this electrode body central part 120f toward the other axial end SB (right side in FIGS. 1 and 11, lower side in FIG. 2).

In the electrode body central part 120f of the wound electrode body 120, in one axial end portion 120fa at the one axial end SA, a one side fluid flow restrictor (fluid flow restrictor) 190 is formed for restricting the flow of electrolyte between inside and outside of the electrode body central part 120f through the one axial end portion 120fa as will be described later (see FIGS. 9 to 11, etc.). In the electrode body central part 120f, in the other axial end portion 120fb at the other axial end SB, the other side fluid flow restrictor (fluid flow restrictor) 195 is formed for restricting the flow of electrolyte between inside and outside of the electrode body central part 120f through the other axial end portion 120fb as will be described later.

First, the positive electrode plate 121 will be described. This positive electrode plate 121 has a positive current collecting foil 122 made of a strip of aluminum foil as a core as shown in FIGS. 3 to 4, and FIGS. 9 to 11. This positive current collecting foil 122 is provided on both main surfaces thereof with positive active material layers 123, 123 in a strip-like shape along the longitudinal direction (left and right direction in FIGS. 3 and 9, a direction orthogonal to the paper plane in FIGS. 4, 10 and 11). This positive active material layer 123 is made of a positive active material, a conductive agent, and a binder.

Of the positive electrode plate 121, a strip-shaped portion where the positive active material layers 123, 123 are present in its thickness direction constitutes a positive electrode portion 121w. This positive electrode portion 121w is located entirely inside the electrode body central part 120f and faces a negative electrode portion 131w of the negative electrode plate 131 to be described later via the separator 141 in the wound electrode body 120 configuration (see FIGS. 9 to 11).

With the positive electrode portion 121w being formed to the positive electrode plate 121, one end (upper side in FIGS. 3 and 9, left side in FIGS. 4, 10, and 11) in the width direction of the positive current collecting foil 122 extending in the longitudinal direction in a strip-like shape forms the positive current collecting portion 121m where no positive active material layers 123 are present in its thickness direction.

This positive current collecting portion 121m includes an inner collector portion 121m1 and an outer collector portion 121m2. The inner collector portion 121m1 is a strip-shaped portion adjacent to the one axial end SA of the positive electrode portion 121w (upper side in FIGS. 3 and 9, left side in FIGS. 4, 10, and 11) and located inside the electrode body central part 120f in the wound electrode body 120 configuration. The outer collector portion 121m2 is a strip-shaped portion adjacent to this inner collector portion 121m1 on the side closer to the one axial end SA and, as mentioned above, protruding toward the one axial end SA from the electrode body central part 120f (separator 141). A first restrictor 191, a second restrictor 192, and a seventh restrictor 198 will be described later.

Next, the negative electrode plate 131 will be described. This negative electrode plate 131 has a negative current collecting foil 132 made of a strip of copper foil as a core as shown in FIGS. 5 to 6, and 9 to 11. This negative current collecting foil 132 is provided on both main surfaces thereof with negative active material layers 133, 133 in a strip-like shape along the longitudinal direction (left and right direction in FIGS. 5 and 9, a direction orthogonal to the paper plane in FIGS. 6, 10, and 11). This negative active material layer 133 is made of a negative active material, a binder, and a thickener.

Of the negative electrode plate 131, the strip-shaped portion where the negative active material layers 133, 133 are present in its thickness direction constitutes the negative electrode portion 131w. This negative electrode portion 131w is a strip-shaped portion located entirely inside the electrode body central part 120f and faces the separator 141 in the wound electrode body 120 configuration.

With the negative electrode portion 131w being formed to the negative electrode plate 131, the other end (lower side in FIGS. 5 and 9, right side in FIGS. 6, 10, and 11) in the width direction of the negative current collecting foil 132 extending in the longitudinal direction in a strip-like shape forms the negative current collecting portion 131m where no negative active material layers 133 are present in its thickness direction.

This negative current collecting portion 131m includes an inner collector portion 131m1 and an outer collector portion 131m2. The inner collector portion 131m1 is a strip-shaped portion adjacent to the other axial end SB of the negative electrode portion 131w (lower side in FIGS. 5 and 9, right side in FIGS. 6, 10, and 11) and located inside the electrode body central part 120f in the wound electrode body 120 configuration. The outer collector portion 131m2 is a strip-shaped portion adjacent to this inner collector portion 131m1 on the side closer to the other axial end SB and, as mentioned above, protruding toward the other axial end SB from the electrode body central part 120f (separator 141). A third restrictor 193, a fifth restrictor 196, and a sixth restrictor 197 will be described later.

The separator 141 is made of a known porous resin such as PP or PE, and in the form of a long strip, as shown in FIGS. 7 to 11. A fourth restrictor 194 and an eighth restrictor 199 will be described later.

Next, a one side fluid flow restrictor 190 will be described. This one side fluid flow restrictor 190 includes a first restrictor 191, a second restrictor 192, a third restrictor 193, and a fourth restrictor 194.

The first restrictor 191 is formed in one axial end portion 123a that is an end portion at the one axial end SA of the positive active material layers 123 such as to clog up the pores therein, as shown in FIGS. 3 to 4, and 9 to 11. This first restrictor 191 is made of a gel-like substance containing the electrolyte and being in the form of a gel, more specifically, a gel-like substance made of polyvinylidene fluoride-co-hexafluoropropylene (P(VDF-HFP)) having absorbed the electrolyte and turned into a gel.

The second restrictor 192 is formed, as shown in FIGS. 3 to 4, and 9 to 11, in a strip-like shape extending in the longitudinal direction of the positive electrode plate 121 and the separator 141, formed in a part (closer to the positive active material layer 123) between the inner collector portion 121m1 of the positive current collecting portion 121m and a positive electrode facing portion 141a of the separator 141 facing this inner collector portion 121m1 (see also FIGS. 7 and 8). This second restrictor 192 is a gel-like substance containing the electrolyte and being in the form of a gel, more specifically, a gel-like substance made of P(VDF-HFP) having absorbed the electrolyte and turned into a gel with fillers such as silica powder (SiO₂) or alumina powder (Al₂O₃).

The third restrictor 193 is formed in one axial end portion 133a that is an end portion at the one axial end SA of the negative active material layers 133 such as to clog up the pores therein as shown in FIGS. 5 to 6, and 9 to 11. This third restrictor 193 is a gel-like substance containing the electrolyte and being in the form of a gel, more specifically, similarly to the first restrictor 191, a gel-like substance made of P(VDF-HFP) having absorbed the electrolyte and turned into a gel.

The fourth restrictor 194 is formed in a strip-like shape extending in the longitudinal direction of the separator 141, formed between one end facing parts 141c, 141c of the separator 141 located at one end in the axial direction AX (upper side in FIGS. 7 and 9, left side in FIGS. 8, 10, and 11). This fourth restrictor 194 is a gel-like substance containing the electrolyte and being in the form of a gel, more specifically, similarly to the second restrictor 192, a gel-like substance made of P(VDF-HFP) having absorbed the electrolyte and turned into a gel with fillers such as silica powder (SiO₂) or alumina powder (Al₂O₃).

Next, the other side fluid flow restrictor 195 will be described. This the other side fluid flow restrictor 195 includes a fifth restrictor 196, a sixth restrictor 197, a seventh restrictor 198, and an eighth restrictor 199.

The fifth restrictor 196 is formed in the other axial end portion 133b that is an end portion at the other axial end SB of the negative active material layers 133 such as to clog up the pores therein as shown in FIGS. 5 to 6, and 9 to 11. This fifth restrictor 196 is a gel-like substance containing the electrolyte and being in the form of a gel, more specifically, similarly to the first restrictor 191 and the third restrictor 193, a gel-like substance made of P(VDF-HFP) having absorbed the electrolyte and turned into a gel.

The sixth restrictor 197 is formed, as shown in FIGS. 5 to 6, and 9 to 11, in a strip-like shape extending in the longitudinal direction of the negative electrode plate 131 and the separator 141, the sixth restrictor 197 being formed between the inner collector portion 131m1 of the negative current collecting portion 131m and a negative electrode facing portion 141b of the separator 141 facing this inner collector portion 131m1 (see also FIGS. 7 and 8). This sixth restrictor 197 is a gel-like substance containing the electrolyte and being in the form of a gel, more specifically, similarly to the second restrictor 192 and the fourth restrictor 194, a gel-like substance made of P(VDF-HFP) having absorbed the electrolyte and turned into a gel with fillers such as silica powder (SiO₂) or alumina powder (Al₂O₃).

The seventh restrictor 198 is formed in the other axial end portion 123b that is an end portion at the other axial end SB of the positive active material layers 123 such as to clog up the pores therein as shown in FIGS. 3 to 4, and 9 to 11. This seventh restrictor 198 is a gel-like substance containing the electrolyte and being in the form of a gel, more specifically, similarly to the first, third, and fifth restrictors 191, 193, and 196, a gel-like substance made of P(VDF-HFP) having absorbed the electrolyte and turned into a gel.

The eighth restrictor 199 is formed in a strip-like shape extending in the longitudinal direction of the separator 141, the eighth restrictor 199 being in a part (closer to the other axial end SB) between the other end facing parts 141d, 141d of the separators 141, 141 located at the other end in the axial direction AX (lower side in FIGS. 7 and 9, right side in FIGS. 8, 10, and 11). This eighth restrictor 199 is a gel-like substance containing the electrolyte and being in the form of a gel, more specifically, similarly to the second, fourth, and sixth restrictors 192, 194, and 197, a gel-like substance made of P(VDF-HFP) having absorbed the electrolyte and turned into a gel with fillers such as silica powder (SiO₂) or alumina powder (Al₂O₃).

As described above, the wound electrode body 120 of the lithium ion secondary battery 100 in Embodiment 1 includes the fluid flow restrictors (the one side fluid flow restrictor 190 and the other side fluid flow restrictor 195). More specifically, the wound electrode body 120 includes the one side fluid flow restrictor 190 consisting of the first restrictor 191 to the fourth restrictor 194 in the one axial end portion 120fa of the electrode body central part 120f, and the other side fluid flow restrictor 195 consisting of the fifth restrictor 196 to the eighth restrictor 199 in the other axial end portion 120fb of the electrode body central part 120f.

When this lithium ion secondary battery 100 is discharged at a high rate in low temperature environments, the concentration of lithium ions in the electrolyte near the negative active material layers 133 is increased, pressure is applied to the electrolyte existing in the electrode body central part 120f with thermal expansion of the wound electrode body 120, and this pressure acts to push the electrolyte with higher ion concentration out of the electrode body. In Embodiment 1, however, as the wound electrode body 120 is provided with the fluid flow restrictors (the one side fluid flow restrictor 190 and the other side fluid flow restrictor 195) as described above, the electrolyte is prevented from being pushed out of the wound electrode body 120 (more particularly, electrode body central part 1200. Accordingly, a gradual decrease of lithium ion concentration of the electrolyte inside the electrode body central part 120f caused by repetition of such discharge is prevented, and therefore, even when high-rate discharge is repeated in low temperature environments, a decrease in the apparent battery capacity due to increased internal resistance can be prevented.

On the other hand, when the battery is charged at a high rate in low temperature environments, the concentration of lithium ions in the electrolyte near the negative active material layers 133 is lowered, pressure is applied to the electrolyte existing in the electrode body central part 120f with thermal expansion of the wound electrode body 120, and this pressure acts to push the electrolyte with lower ion concentration out of the electrode body. In this case, too, the fluid flow restrictors (the one side fluid flow restrictor 190 and the other side fluid flow restrictor 195) can prevent the electrolyte from being pushed out of the wound electrode body 120 (more particularly, electrode body central part 1200. Accordingly, a gradual increase of lithium ion concentration of the electrolyte inside the electrode body central part 120f caused by repetition of such charge is prevented, and therefore, even when high-rate charge is repeated in low temperature environments, a decrease in the apparent battery capacity due to increased internal resistance can be prevented.

Further, in Embodiment 1, the one side fluid flow restrictor 190 includes the first restrictor 191 to the fourth restrictor 194. The first restrictor 191 is formed inside pores in the one axial end portion 123a of the positive active material layers 123, so that the electrolyte is prevented from being pushed out of the electrode body central part 120f through the pores.

The second restrictor 192 is formed between the inner collector portion 121m1 of the positive current collecting portion 121m and the positive electrode facing portion 141a of the separator 141, so that the electrolyte is prevented from being pushed out of the electrode body central part 120f through between the positive current collecting portion 121m (inner collector portion 121m1) and the separator 141 (positive electrode facing portion 141a).

The third restrictor 193 is formed inside pores in the one axial end portion 133a of the negative active material layers 133, so that the electrolyte is prevented from being pushed out of the electrode body central part 120f through the pores.

The fourth restrictor 194 is formed between the one end facing parts 141c, 141c of the separators 141, 141, so that the electrolyte is prevented from being pushed out of the electrode body central part 120f through between the separators 141, 141 (one end facing parts 141c, 141c).

Also, in Embodiment 1, the other side fluid flow restrictor 195 includes the fifth restrictor 196 to the eighth restrictor 199. The fifth restrictor 196 is formed inside pores in the other axial end portion 133b of the negative active material layers 133, so that the electrolyte is prevented from being pushed out of the electrode body central part 120f through the pores.

The sixth restrictor 197 is formed between the inner collector portion 131m1 of the negative current collecting portion 131m and the negative electrode facing portion 141b of the separator 141, so that the electrolyte is prevented from being pushed out of the electrode body central part 120f through between the negative current collecting portion 131m (inner collector portion 131m1) and the separator 141 (negative electrode facing portion 141b).

The seventh restrictor 198 is formed inside pores in the other axial end portion 123b of the positive active material layers 123, so that the electrolyte is prevented from being pushed out of the electrode body central part 120f through the pores.

The eighth restrictor 199 is formed between the other end facing parts 141d, 141d of the separators 141, 141, so that the electrolyte is prevented from being pushed out of the electrode body central part 120f through between the separators 141, 141 (the other end facing parts 141d, 141d).

Accordingly, in this lithium ion secondary battery 100, a gradual change of lithium ion concentration of the electrolyte inside the electrode body central part 120f is prevented even when high-rate discharge or charge is repeated in low temperature environments, and therefore a decrease in the apparent battery capacity due to increased internal resistance is prevented.

In Embodiment 1, since the one side fluid flow restrictor 190 and the other side fluid flow restrictor 195 are formed by a gel-like substance containing the electrolyte and being in the form of a gel, they can effectively prevent the electrolyte from being pushed out of the electrode body central part 120f. Accordingly, in this lithium ion secondary battery 100, a gradual change of lithium ion concentration of the electrolyte inside the electrode body central part 120f is prevented even when high-rate discharge or charge is repeated in low temperature environments, and therefore a decrease in the apparent battery capacity due to increased internal resistance is effectively prevented. Being a gel-like substance, the one side fluid flow restrictor 190 and the other side fluid flow restrictor 195 can readily follow any shape changes of the wound electrode body 120 that may accompany temperature changes and do not impede deformation of the wound electrode body 120.

Next, the method for manufacturing the lithium ion secondary battery 100 will be described.

First, the positive electrode plate 121 is fabricated. Namely, the positive current collecting foil 122 made of a strip of aluminum foil is prepared. Then, a positive active material paste containing a positive active material, a conductive agent, and a binder is applied on one main surface of this foil 122 while forming the strip-shaped positive current collecting portion 121m extending in the longitudinal direction and dried with hot air to form a strip-shaped positive electrode portion 121w. Similarly, the positive active material paste is applied on the opposite main surface of the positive current collecting foil 122 while forming the strip-shaped positive current collecting portion 121m and dried with hot air to form the strip-shaped positive electrode portion 121w. After that, the positive active material layers 123 are compressed using a pressure roller in order to increase electrode density.

Next, as a first formation step of a pre-processed restrictor formation step, a first pre-processed restrictor 191x, which corresponds to the first restrictor 191 and will be subjected to a predetermined flow restricting process (in Embodiment 1, a heating process to be described later) to reduce flowability of the electrolyte therethrough in the axial direction AX (width direction), is formed on this positive electrode plate 121 (see FIGS. 3 and 4). Concurrently, as a seventh formation step of the pre-processed restrictor formation step, a seventh pre-processed restrictor 198x, which corresponds to the seventh restrictor 198 and will be subjected to the above-noted flow restricting process to reduce flowability of the electrolyte therethrough in the axial direction AX (width direction), is formed on this positive electrode plate 121. In Embodiment 1, the first pre-processed restrictor 191x and the seventh pre-processed restrictor 198x are formed by a gelling material that absorbs the electrolyte and turns into a gel upon being heated.

More specifically, polyvinylidene fluoride-co-hexafluoropropylene (P(VDF-HFP)), which is one of such a gelling material, is prepared. A coating liquid obtained by mixing this P(VDF-HFP) in N-methylpyrrolidone (NMP) as a solvent is applied to portions of the positive electrode plate 121 which will form the first restrictor 191 and the seventh restrictor 198, i.e., to the one axial end portion 123a and the other axial end portion 123b of the positive active material layers 123, respectively. The pores in the one axial end portion 123a and the other axial end portion 123b are thus filled with the coating liquid. After that, the positive electrode plate 121 is dried to remove NMP so as to form the first pre-processed restrictor 191x and the seventh pre-processed restrictor 198x inside the pores of the one axial end portion 123a and the other axial end portion 123b, respectively.

A plasticizer may be mixed in the coating liquid to increase the porosity of the one axial end portion 123a and the other axial end portion 123b with the first and seventh pre-processed restrictors 191x and 198x being formed therein. For example, a plasticizer such as dibutylphthalate (DBP) may further be mixed in the coating liquid which may then be applied to the one axial end portion 123a and the other axial end portion 123b of the positive active material layers 123 of the positive electrode plate 121 and dried to remove NMP. After that, the positive electrode plate 121 may further be subjected to vacuum drying in a high temperature to remove DBP. Alternatively, DBP may be removed by using xylene or the like. The porosity can be made large through these steps, which improves permeability of the electrolyte, so that the electrolyte can be injected favorably in the electrolyte injecting step to be described later. Also, as the first and seventh pre-processed restrictors 191x and 198x can be impregnated with more electrolyte, they can be turned into a gel efficiently in the restrictor formation step to be described later.

Next, as a second formation step of the pre-processed restrictor formation step, a second pre-processed restrictor 192x, which corresponds to the second restrictor 192 and will be subjected to a predetermined flow restricting process (in Embodiment 1, a heating process to be described later) to reduce flowability of the electrolyte therethrough in the axial direction AX (width direction), is formed on this positive electrode plate 121 (see FIGS. 3 and 4). In Embodiment 1, this second pre-processed restrictor 192x is also formed by a gelling material that absorbs the electrolyte and turns into a gel upon being heated.

More specifically, a coating liquid obtained by mixing a gelling material such as P(VDF-HFP) in NMP with fillers such as silica powder (SiO₂) or alumina powder (Al₂O₃) is applied to a portion of the positive electrode plate 121 which will form the second restrictor 192, i.e., to a part of the inner collector portion 121m1 of the positive current collecting portion 121m closer to the positive active material layer 123. After that, this positive electrode plate 121 is dried to remove NMP to form the second pre-processed restrictor 192x having a porous structure. Thus the positive electrode plate 121 is formed. In this second formation step, too, a plasticizer may be mixed in the coating liquid to increase the porosity of the second pre-processed restrictor 192x. DBP, for example, as a plasticizer may further be mixed in the coating liquid, which may be applied to a part of the inner collector portion 121m1 of the positive electrode plate 121 and dried to remove NMP. After that, the positive electrode plate 121 may further be subjected to vacuum drying in a high temperature to remove DBP. Alternatively, DBP may be removed by using xylene or the like. The porosity of the second pre-processed restrictor 192x can be made large through these steps, which improves permeability of the electrolyte, so that the electrolyte can be injected favorably in the electrolyte injecting step to be described later. Also, as the second pre-processed restrictor 192x can be impregnated with more electrolyte, it can be turned into a gel efficiently in the restrictor formation step to be described later.

The negative electrode plate 131 is fabricated separately. Namely, the negative current collecting foil 132 made of a strip of copper foil is prepared. Then, a negative active material paste containing a negative active material, a binder, and a thickener is applied on one main surface of this foil 132 while forming the strip-shaped negative current collecting portion 131m extending in the longitudinal direction and dried with hot air to form a strip-shaped negative electrode portion 131w. Similarly, the negative active material paste is applied on the opposite main surface of this foil 132 while forming the strip-shaped negative current collecting portion 131m and dried with hot air to form the strip-shaped negative electrode portion 131w. After that, the negative active material layers 133 are compressed using a pressure roller in order to increase electrode density.

Next, as a third formation step of the pre-processed restrictor formation step, a third pre-processed restrictor 193x, which corresponds to the third restrictor 193 and will be subjected to a predetermined flow restricting process (in Embodiment 1, a heating process to be described later) to reduce flowability of the electrolyte therethrough in the axial direction AX (width direction), is formed on this negative electrode plate 131 (see FIGS. 5 and 6). Concurrently, as a fifth formation step of the pre-processed restrictor formation step, a fifth pre-processed restrictor 196x, which corresponds to the fifth restrictor 196 and will be subjected to the above-noted flow restricting process to reduce flowability of the electrolyte therethrough in the axial direction AX (width direction), is formed on this negative electrode plate 131. In Embodiment 1, both of the third and fifth pre-processed restrictors 193x and 196x are also formed by a gelling material that absorbs the electrolyte and turns into a gel upon being heated.

More specifically, a coating liquid obtained by mixing a gelling material such as P(VDF-HFP) in NMP similarly to the first and seventh formation steps is applied to portions of the negative electrode plate 131 which will form the third restrictor 193 and the fifth restrictor 196, i.e., to the one axial end portion 133a and the other axial end portion 133b of the negative active material layers 133, respectively. After that, the negative electrode plate 131 is dried to remove NMP so as to form the third pre-processed restrictor 193x and the fifth pre-processed restrictor 196x inside the pores of the one axial end portion 133a and the other axial end portion 133b, respectively.

In these third and fifth formation steps, too, a plasticizer may be mixed in the coating liquid similarly to the previously described first and seventh formation steps to increase the porosity of the one axial end portion 133a and the other axial end portion 133b with the third and fifth pre-processed restrictors 193x and 196x being formed therein.

Next, as a sixth formation step of the pre-processed restrictor formation step, a sixth pre-processed restrictor 197x, which corresponds to the sixth restrictor 197 and will be subjected to a predetermined flow restricting process (in Embodiment 1, a heating process to be described later) to reduce flowability of the electrolyte therethrough in the axial direction AX (width direction), is formed on the negative electrode plate 131 (see FIGS. 5 and 6). In Embodiment 1, this sixth pre-processed restrictor 197x is also formed by a gelling material that absorbs the electrolyte and turns into a gel upon being heated.

More specifically, similarly to the previously described second formation step, a coating liquid obtained by mixing a gelling material such as P(VDF-HFP) in NMP with fillers such as silica powder or alumina powder is applied to a portion of the negative electrode plate 131 which will form the sixth restrictor 197, i.e., to a part of the inner collector portion 131m1 of the negative current collecting portion 131m closer to the negative active material layer 133. After that, this negative electrode plate 131 is dried to remove NMP to form the sixth pre-processed restrictor 197x having a porous structure. Thus the negative electrode plate 131 is formed.

In this sixth formation step, too, similarly to the previously described second formation step, a plasticizer may be mixed in the coating liquid to increase the porosity of the sixth pre-processed restrictor 197x.

Next, a strip of separator 141 is prepared. As a fourth formation step of the pre-processed restrictor formation step, a fourth pre-processed restrictor 194x, which corresponds to the fourth restrictor 194 and will be subjected to a predetermined flow restricting process (in Embodiment 1, a heating process to be described later) to reduce flowability of the electrolyte therethrough in the axial direction AX (width direction), is formed on this separator 141 (see FIGS. 7 and 8). Concurrently, as an eighth formation step of the pre-processed restrictor formation step, an eighth pre-processed restrictor 199x, which corresponds to the eighth restrictor 199 and will be subjected to the flow restricting process to reduce flowability of the electrolyte therethrough in the axial direction AX (width direction), is formed on this separator 141. In Embodiment 1, both of the fourth and eighth pre-processed restrictors 194x and 199x are also formed by a gelling material that absorbs the electrolyte and turns into a gel upon being heated.

More specifically, similarly to the previously described second and sixth formation steps, a coating liquid obtained by mixing a gelling material such as P(VDF-HFP) in NMP with fillers such as silica powder or alumina powder is applied to portions of the separator 141 which will form the fourth restrictor 194 and the eighth restrictor 199, i.e., to a part of one main surface of the one end facing part 141c and to a part of the other main surface of the other facing part 141d, respectively. After that, this separator 141 is dried to remove NMP to form the fourth and eighth pre-processed restrictors 194x and 199x. Thus the separator 141 is formed.

In these fourth and eighth formation steps, too, similarly to the previously described second and sixth formation steps, a plasticizer may be mixed in the coating liquid to increase the porosity of the fourth and eighth pre-processed restrictors 194x and 199x.

Next, in a winding step of the pre-processed restrictor formation step, the positive electrode plate 121 and the negative electrode plate 131 are overlapped upon one another via the separator 141 (see FIGS. 9 and 10) and wound around the axis AX using a winding core. After that, in a compression step, these are compressed into a flat shape to form the wound electrode body 120 (see FIG. 2). Thus, the pre-processed fluid flow restrictors (the pre-processed one side fluid flow restrictor 190x and the pre-processed the other side fluid flow restrictor 195x) are formed in the wound electrode body 120. More specifically, the pre-processed one side fluid flow restrictor 190x consisting of the first to fourth pre-processed restrictors 191x to 194x is formed in the one axial end portion 120fa of the electrode body central part 120f in the wound electrode body 120, and the pre-processed the other side fluid flow restrictor 195x consisting of the fifth to eighth pre-processed restrictors 196x to 199x is formed in the other axial end portion 120fb of the electrode body central part 120f.

Next, the case lid member 113, three types of insulators 181, 183, and 185, and three types of metal terminal fittings 151, 153, and 155 are prepared (see FIG. 12) to fixedly attach the positive and negative terminal members 150 and 160 to the case lid member 113 such that the positive terminal member 150 is connected to the positive current collecting portion 121m (outer collector portion 121m2) of the wound electrode body 120, and the negative terminal member 160 is connected to the negative current collecting portion 131m (outer collector portion 131m2) of the wound electrode body 120. Next, the case body 111 is prepared and the wound electrode body 120 is inserted into the case body 111. After that, the case lid member 113 is welded to the case body 111 by laser welding to form the battery case 110.

Next, in the electrolyte injecting step, the electrolyte is injected into the battery case 110 through the electrolyte injection port 113d to fill the electrode body central part 120f with electrolyte through the respective pre-processed fluid flow restrictors (the pre-processed one side fluid flow restrictor 190x and the pre-processed the other side fluid flow restrictor 195x). After that, the electrolyte injection port 113d is sealed.

Next, in the restrictor formation step, a predetermined flow restricting process (in Embodiment 1, heating process) is performed to reduce flowability of the electrolyte through the pre-processed one side fluid flow restrictor 190x in the axial direction AX, thereby turning the pre-processed one side fluid flow restrictor 190x into the one side fluid flow restrictor 190, and to reduce flowability of the electrolyte through the pre-processed the other side fluid flow restrictor 195x in the axial direction AX, thereby turning the pre-processed the other side fluid flow restrictor 195x into the other side fluid flow restrictor 195.

More specifically, the lithium ion secondary battery 100 is kept under a temperature of 90 to 100° C. for about 30 minutes to 3 hours. The battery is then let cool down to normal temperature. This heating process causes P(VDF-HFP), which is a gelling material, to absorb the electrolyte and turn into a gel to reduce flowability of the electrolyte therethrough, and thus the first to fourth pre-processed restrictors 191x to 194x turn into the first to fourth restrictors 191 to 194, and the fifth to eighth pre-processed restrictors 196x to 199x turn into the fifth to eighth restrictors 196 to 199. The fluid flow restrictors (the one side fluid flow restrictor 190 and the other side fluid flow restrictor 195) are formed this way.

After that, a high temperature aging and various inspections are performed. Thus, the lithium ion secondary battery 100 is completed.

As described above, with the method for manufacturing the lithium ion secondary battery 100 of Embodiment 1, the wound electrode body 120 is first formed with the pre-processed fluid flow restrictors (the pre-processed one side fluid flow restrictor 190x and the pre-processed the other side fluid flow restrictor 195x), which will be subjected to a predetermined flow restricting process (heating process in Embodiment 1) to reduce flowability of the electrolyte therethrough in the axial direction AX (pre-processed restrictor formation step). More specifically, the pre-processed one side fluid flow restrictor 190x is formed in the one axial end portion 120fa of the electrode body central part 120f, and the pre-processed the other side fluid flow restrictor 195x is formed in the other axial end portion 120fb of the electrode body central part 120f of the wound electrode body 120. After injecting electrolyte into the electrode body central part 120f through the pre-processed fluid flow restrictors (the pre-processed one side fluid flow restrictor 190x and the pre-processed the other side fluid flow restrictor 195x) (the electrolyte injecting step), the flow restricting process is performed to form the fluid flow restrictors (the one side fluid flow restrictor 190 and the other side fluid flow restrictor 195).

Therefore, when the electrolyte is injected into the electrode body central part 120f, its flowability through the pre-processed one side fluid flow restrictor 190x and the pre-processed the other side fluid flow restrictor 195x has not been lowered yet, so that the electrolyte can be injected into the electrode body central part 120f through the pre-processed fluid flow restrictors on one and the other sides 190x and 195x. The fluid flow restrictors on the one and the other sides 190 and 195 are formed easily, as they are formed by performing predetermined flow restricting process (in Embodiment 1, heating process) after the electrolyte has been injected into the electrode body central part 120f.

In Embodiment 1, the first pre-processed restrictor 191x is formed in the one axial end portion 123a of the positive active material layers 123, which is then turned into the first restrictor 191, so that the electrolyte is prevented from being pushed out of the electrode body central part 120f through the pores of the one axial end portion 123a.

The second pre-processed restrictor 192x is formed between the inner collector portion 121m1 of the positive current collecting portion 121m and the positive electrode facing portion 141a of the separator 141, which is then turned into the second restrictor 192, so that the electrolyte is prevented from being pushed out of the electrode body central part 120f through between the positive current collecting portion 121m (inner collector portion 121m1) and the separator 141 (positive electrode facing portion 141a).

The third pre-processed restrictor 193x is formed in the one axial end portion 133a of the negative active material layers 133, which is then turned into the third restrictor 193, so that the electrolyte is prevented from being pushed out of the electrode body central part 120f through the pores of the one axial end portion 133a.

The fourth pre-processed restrictor 194x is formed between the one end facing parts 141c, 141c of the separators 141, 141, which is then turned into the fourth restrictor 194, so that the electrolyte is prevented from being pushed out of the electrode body central part 120f through between the one end facing parts 141c, 141c of the separators 141, 141.

The fifth pre-processed restrictor 196x is formed in the other axial end portion 133b of the negative active material layers 133, which is then turned into the fifth restrictor 196, so that the electrolyte is prevented from being pushed out of the electrode body central part 120f through the pores of the other axial end portion 133b.

The sixth pre-processed restrictor 197x is formed between the inner collector portion 131m1 of the negative current collecting portion 131m and the negative electrode facing portion 141b of the separator 141, which is then turned into the sixth restrictor 197, so that the electrolyte is prevented from being pushed out of the electrode body central part 120f through between the negative current collecting portion 131m (inner collector portion 131m1) and the separator 141 (negative electrode facing portion 141b).

The seventh pre-processed restrictor 198x is formed in the other axial end portion 123b of the positive active material layers 123, which is then turned into the seventh restrictor 198, so that the electrolyte is prevented from being pushed out of the electrode body central part 120f through the pores of the other axial end portion 123b.

The eighth pre-processed restrictor 199x is formed between the other end facing parts 141d, 141d of the separators 141, 141, which is then turned into the eighth restrictor 199, so that the electrolyte is prevented from being pushed out of the electrode body central part 120f through between the other end facing parts 141d, 141d of the separators 141, 141.

In Embodiment 1, as mentioned above, the pre-processed one side fluid flow restrictor 190x and the pre-processed the other side fluid flow restrictor 195x are both formed of a gelling material (P(VDF-HFP)) which absorbs the electrolyte and turns into a gel when heated, and the one side fluid flow restrictor 190 and the other side fluid flow restrictor 195 are formed by performing a heating process. Therefore, the fluid flow restrictors on one and the other sides 190 and 195 are formed easily.

While the pre-processed one side fluid flow restrictor 190x and the pre-processed the other side fluid flow restrictor 195x are both formed of a gelling material as noted above in Embodiment 1, these pre-processed fluid flow restrictors on one and the other sides 190x and 195x may be formed of a porous resin whose pores are clogged up when heated or otherwise processed.

Namely, a porous resin sheet, for example, may be bonded on the positive electrode plate 121, the negative electrode plate 131, and the separator 141, instead of applying a coating liquid containing a gelling material, to form the pre-processed fluid flow restrictors on one and the other sides made of a porous resin in the one axial end portion 120fa and the other axial end portion 120fb of the electrode body central part 120f of the wound electrode body 120 (pre-processed restrictor formation step). After that, the electrolyte is injected into the electrode body central part 120f through these pre-processed fluid flow restrictors on one and the other sides (electrolyte injecting step). After that, a heating process is performed to clog up the pores in the resin to reduce flowability of the electrolyte through the pre-processed fluid flow restrictors on one and the other sides, thereby forming the fluid flow restrictors on one and the other sides (restrictor formation step).

### Reference Embodiment

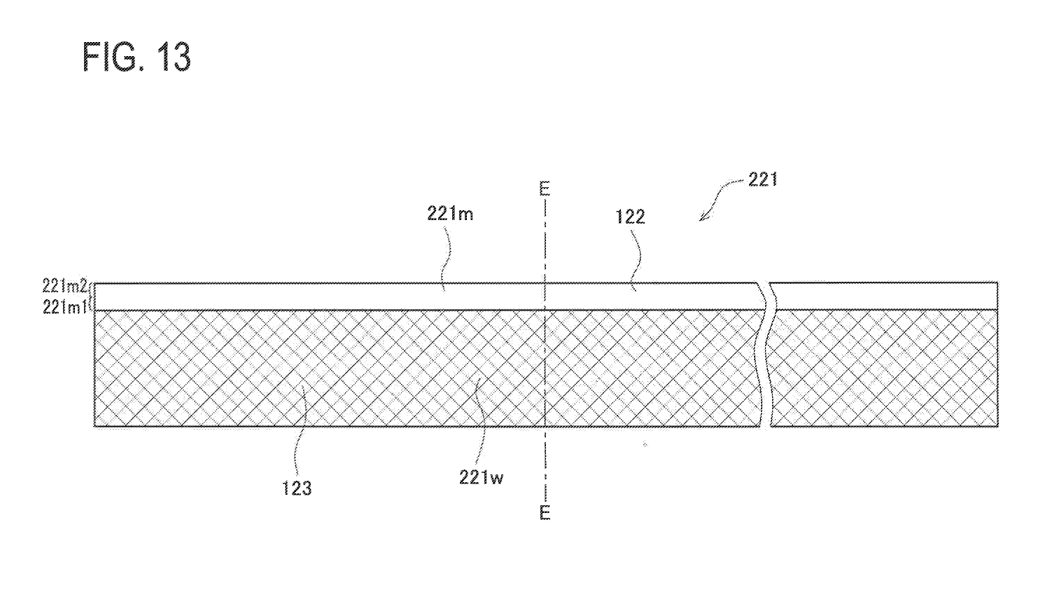

Next, a reference embodiment will be described with reference to FIGS. 13 to 21. In a lithium ion secondary battery (secondary battery) 200 of the reference embodiment, the configuration and forming method of fluid flow restrictors (a one side fluid flow restrictor 290 and the other side fluid flow restrictor 295) are different from those of the fluid flow restrictors (the one side fluid flow restrictor 190 and the other side fluid flow restrictor 195) of the lithium ion secondary battery 100 of Embodiment 1. Other features are similar to Embodiment 1 described above, and therefore description of parts similar to Embodiment 1 will be omitted or simplified.

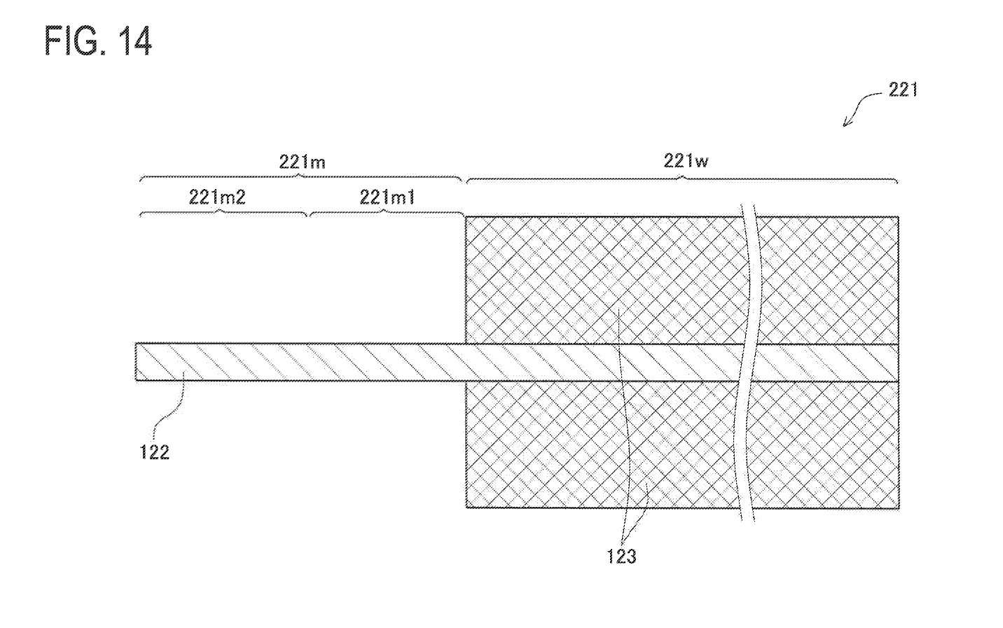

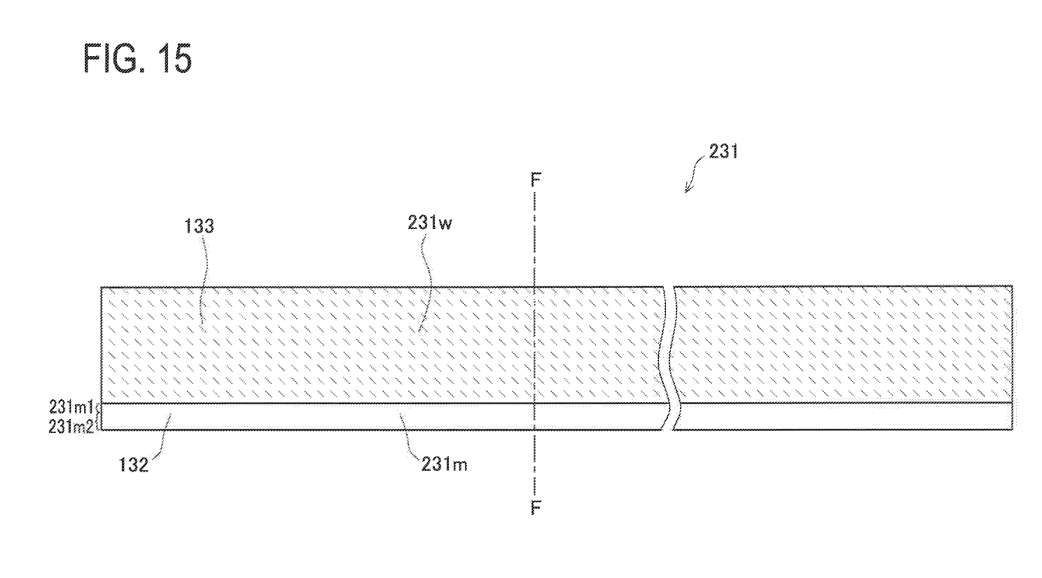

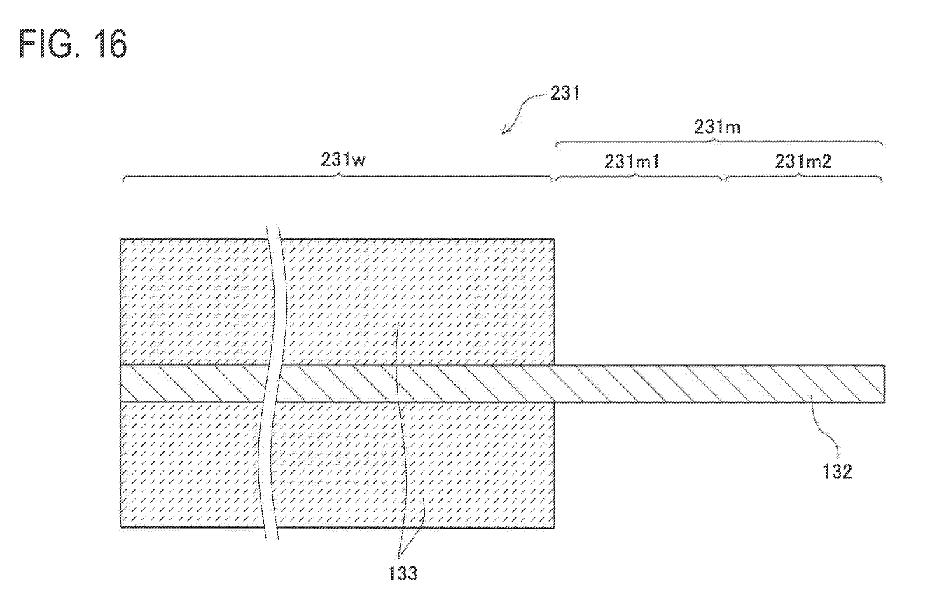

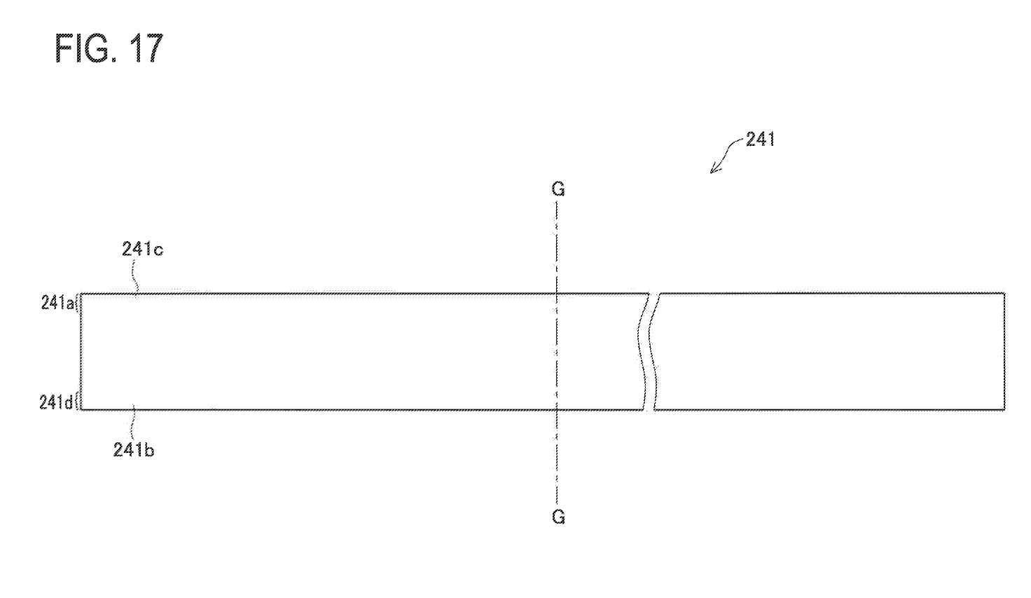

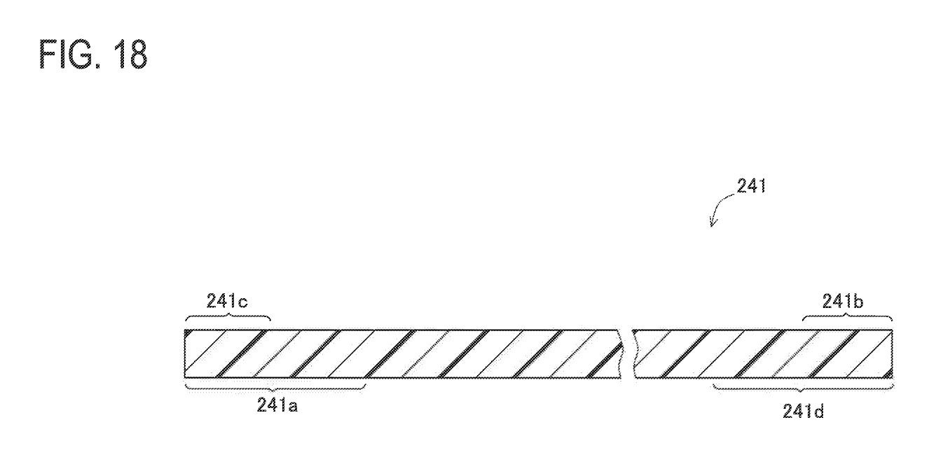

A wound electrode body 220 according to the reference embodiment is formed by winding an elongated positive electrode plate 221 (see FIGS. 13 and 14) and an elongated negative electrode plate 231 (see FIGS. 15 and 16) overlapped upon one another via an elongated separator 241 (see FIGS. 17 and 18) around an axis AX and by compressing these into a flat shape (see FIGS. 19 to 21, and 2).

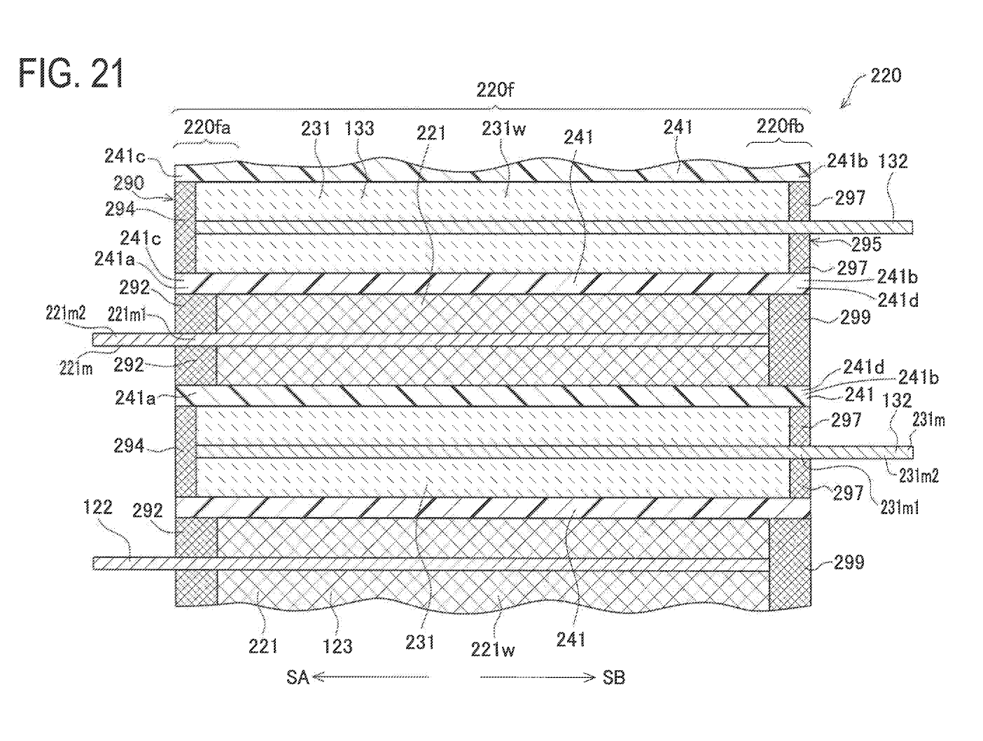

The wound electrode body 220 includes an electrode body central part 220f in the center in the axial direction AX, which is a part where the separator 241 exists in a radial direction of the axis AX. In one axial end portion 220fa of this electrode body central part 220f, as will be described later, a one side fluid flow restrictor 290 is formed for restricting flow of electrolyte between inside and outside of the electrode body central part 220f through the one axial end portion 220fa (see FIG. 21). In the other axial end portion 220fb of the electrode body central part 220f, as will be described later, the other side fluid flow restrictor 295 is formed for restricting flow of the electrolyte between inside and outside of the electrode body central part 220f through the other axial end portion 220fb.

The positive electrode plate 221 includes a positive current collecting foil 122 and a positive active material layers 123, 123 similar to those of Embodiment 1 as shown in FIGS. 13 to 14, and 19 to 21. Of the positive electrode plate 221, a strip-shaped portion where the positive active material layers 123, 123 are present in its thickness direction constitutes a positive electrode portion 221w, while a strip-shaped portion where no positive active material layers 123 are present in its thickness direction constitutes a positive current collecting portion 221m. This positive current collecting portion 221m includes an inner collector portion 221m1 and an outer collector portion 221m2.

The negative electrode plate 231 includes a negative current collecting foil 132 and a negative active material layers 133, 133 similar to those of Embodiment 1 as shown in FIGS. 15 to 16, and 19 to 21. Of the negative electrode plate 231, the strip-shaped portion where the negative active material layers 133, 133 are present in its thickness direction constitutes a negative electrode portion 231w, while the strip-shaped portion where no negative active material layers 133 are present in its thickness direction constitutes a negative current collecting portion 231m. This negative current collecting portion 231m includes an inner collector portion 231m1 and an outer collector portion 231m2.

The separator 241 (see FIGS. 17 to 18, and 19 to 21) is made of a known resin and in the shape of a strip.

The one side fluid flow restrictor 290 according to the reference embodiment includes a second restrictor 292 and a fourth restrictor 294 as shown in the partial cross-sectional view of the wound electrode body 220 in FIG. 21. These second and fourth restrictors 292 and 294 are made of a PP resin. Of these, the second restrictor 292 is formed in a strip-like shape extending in the longitudinal direction of the positive electrode plate 221 and the separator 241, the second restrictor 292 being formed between the inner collector portion 221m1 of the positive current collecting portion 221m and a positive electrode facing portion 241a of the separator 241. The fourth restrictor 294 is formed in a strip-like shape extending in the longitudinal direction of the separator 241, the fourth restrictor being formed between one end facing parts 241c, 241c of the separators 241, 241.

The other side fluid flow restrictor 295 includes a sixth restrictor 297 and an eighth restrictor 299. These sixth and eighth restrictors 297 and 299 are also made of a PP resin. Of these, the sixth restrictor 297 is formed in a strip-like shape extending in the longitudinal direction of the negative electrode plate 231 and the separator 241, the sixth restrictor being formed between the inner collector portion 231m1 of the negative current collecting portion 231m and a negative electrode facing portion 241b of the separator 241. The eighth restrictor 299 is formed in a strip-like shape extending in the longitudinal direction of the separator 241, the eighth restrictor 299 being formed between the other end facing parts 241d, 241d of the separators 241, 241.

When this lithium ion secondary battery 200 is discharged (or charged) at a high rate in low temperature environments, the concentration of lithium ions in the electrolyte near the negative active material layers 133 is increased (or lowered when charged), pressure is applied to the electrolyte existing in the electrode body central part 220f with thermal expansion of the wound electrode body 220, and this pressure acts to push the electrolyte out of the electrode body. In the reference embodiment, too, as the wound electrode body 220 is provided with the fluid flow restrictors (the one side fluid flow restrictor 290 and the other side fluid flow restrictor 295), the electrolyte is prevented from being pushed out of the wound electrode body 220 (more particularly, electrode body central part 2200. Accordingly, a gradual decrease (or increase when charged) of lithium ion concentration of the electrolyte inside the electrode body central part 220f caused by repetition of such discharge (or charge) is prevented, and therefore, even when high-rate discharge or charge is repeated in low temperature environments, a decrease in the apparent battery capacity due to increased internal resistance is prevented.

In the reference embodiment, the second restrictor 292 is formed between the inner collector portion 221m1 of the positive current collecting portion 221m and the positive electrode facing portion 241a of the separator 241, so that the electrolyte is prevented from being pushed out of the electrode body central part 220f through between the positive current collecting portion 221m (inner collector portion 221m1) and the separator 241 (positive electrode facing portion 241a).

The fourth restrictor 294 is formed between the one end facing parts 241c, 241c of the separators 241, 241, so that the electrolyte is prevented from being pushed out of the electrode body central part 220f through between the separators 241, 241 (one end facing parts 241c, 241c).

The sixth restrictor 297 is formed between the inner collector portion 231m1 of the negative current collecting portion 231m and the negative electrode facing portion 241b of the separator 241, so that the electrolyte is prevented from being pushed out of the electrode body central part 220f through between the negative current collecting portion 231m (inner collector portion 231m1) and the separator 241 (negative electrode facing portion 241b).

The eighth restrictor 299 is formed between the other end facing parts 241d, 241d of the separators 241, 241, so that the electrolyte is prevented from being pushed out of the electrode body central part 220f through between the separators 241, 241 (the other end facing parts 241d, 241d). Other parts similar to Embodiment 1 provide the similar effects as those of Embodiment 1.

Next, a method for manufacturing the lithium ion secondary battery 200 according to the reference embodiment will be described. First, the positive electrode plate 221 is fabricated. Namely, similarly to Embodiment 1, the positive active material layers 123 are formed on both main surfaces of the positive current collecting foil 122 to form the positive electrode plate 221. While the first, second, and seventh formation steps of the pre-processed restrictor formation step follow in Embodiment 1, these steps are not performed to this positive electrode plate 221 in the reference embodiment.

The negative electrode plate 231 is fabricated separately. Namely, similarly to Embodiment 1, the negative active material layers 133 are formed on both main surfaces of the negative current collecting foil 132 to form the negative electrode plate 231. While the third, fifth, and sixth formation steps of the pre-processed restrictor formation step follow in Embodiment 1, these steps are not performed to this negative electrode plate 231 in the reference embodiment.

A strip of separator 241 is prepared. While the fourth and eighth formation steps of the pre-processed restrictor formation step are performed to the separator 241 in Embodiment 1, these steps are not performed to this separator 241 in the reference embodiment.

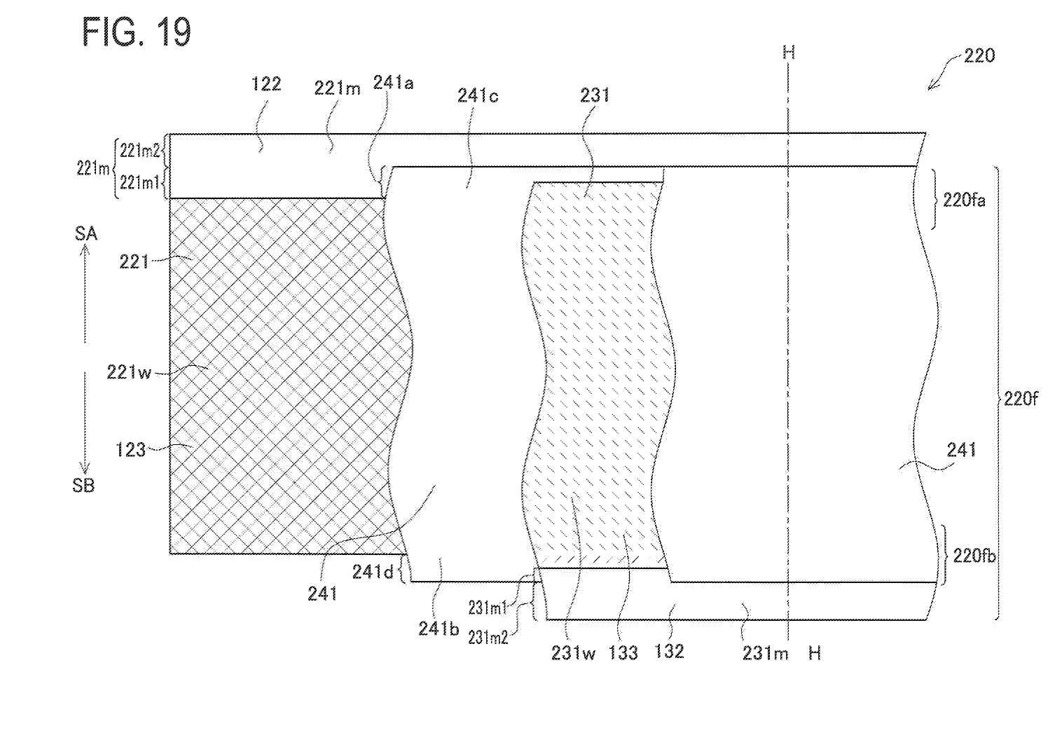

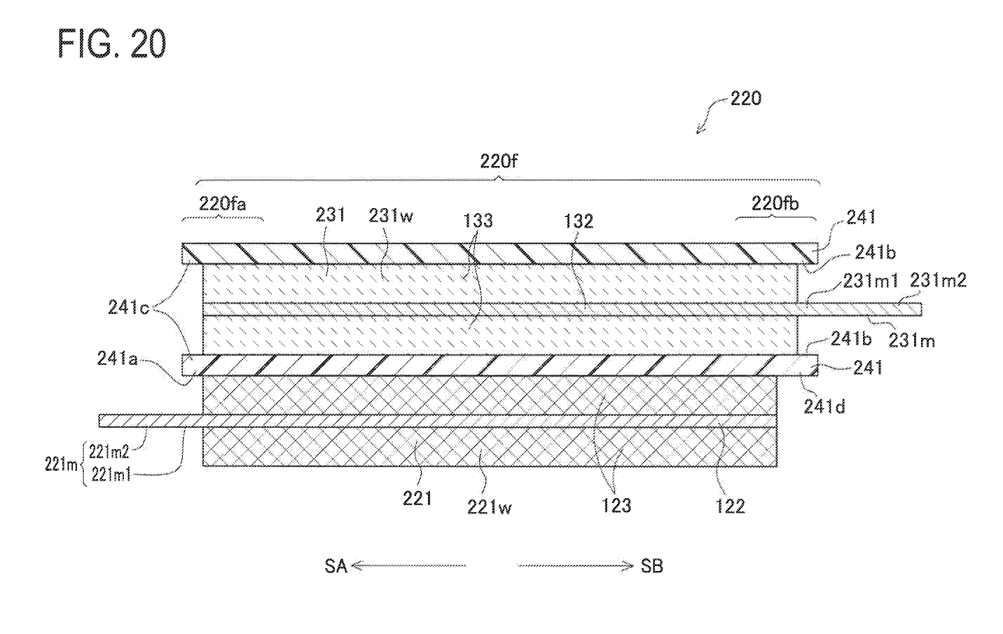

Next, in a winding step, the positive electrode plate 221 and the negative electrode plate 231 are overlapped upon one another via the separator 241 (see FIGS. 19 and 20), and wound around the axis AX by using a winding core. After that, in a compression step, these are compressed into a flat shape to form the wound electrode body 220 (see FIGS. 2 and 21).

Next, in the reference embodiment, the one axial end portion 220fa and the other axial end portion 220fb of the electrode body central part 220f of this wound electrode body 220 are each filled with PP resin using, for example, a syringe, and the resin is cured to form the fluid flow restrictors (the one side fluid flow restrictor 290 and the other side fluid flow restrictor 295). More specifically, PP resin is filled between the inner collector portion 221m1 of the positive current collecting portion 221m and the positive electrode facing portion 241a of the separator 241 to form the second restrictor 292, and between the one end facing parts 241c, 241c of the separators 241, 241 to form the fourth restrictor 294, thus forming the one side fluid flow restrictor 290 consisting of the second and fourth restrictors 292 and 294. PP resin is also filled between the inner collector portion 231m1 of the negative current collecting portion 231m and the negative electrode facing portion 241b of the separator 241 to form the sixth restrictor 297, and between the other end facing parts 241d, 241d of the separators 241, 241 to form the eighth restrictor 299, thus forming the other side fluid flow restrictor 295 consisting of the sixth and eighth restrictors 297 and 299.

Next, the electrolyte is injected into the electrode body central part 220f of the wound electrode body 220. More specifically, the electrolyte is injected into the electrode body central part 220f through the one axial end portion 220fa or the other axial end portion 220fb by using a syringe or the like.

Next, the case lid member 113, three types of insulators 181, 183, and 185, and three types of metal terminal fittings 151, 153, and 155 are prepared (see FIG. 12) to fixedly attach the positive and negative terminal members 150 and 160 to the case lid member 113 such that the positive terminal member 150 is connected to the positive current collecting portion 221m (outer collector portion 221m2) of the wound electrode body 220, and the negative terminal member 160 is connected to the negative current collecting portion 231m (outer collector portion 231m2) of the wound electrode body 220.

Next, the case body 111 is prepared and the wound electrode body 220 is inserted into the case body 111. After that, the case lid member 113 is welded to the case body 111 by laser welding to form the battery case 110. After that, a high temperature aging and various inspections are performed. Thus, the lithium ion secondary battery 200 is completed.

### Embodiment 3

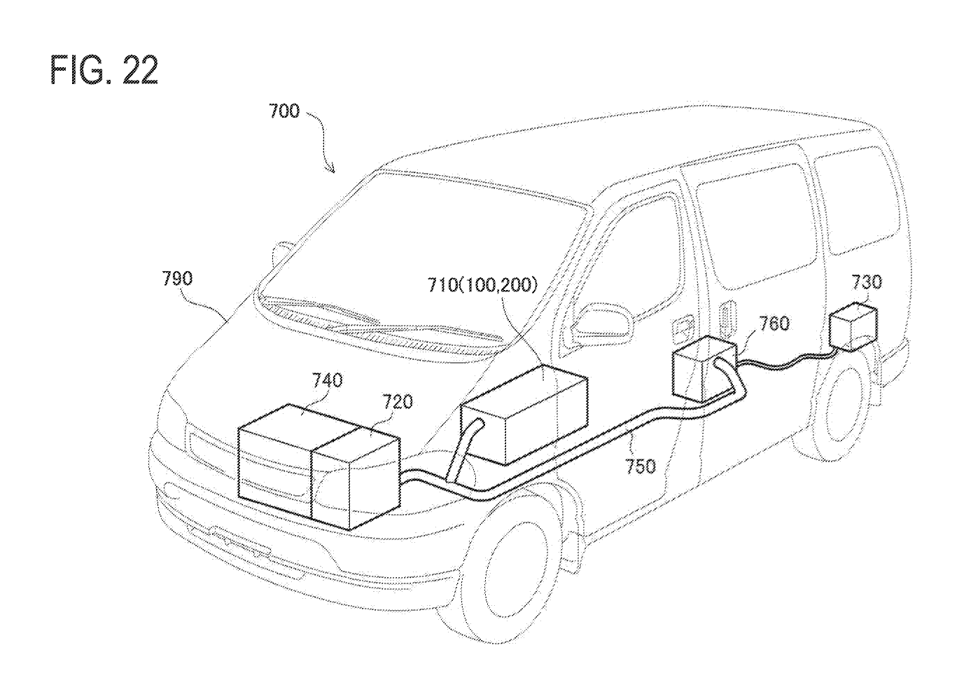

Next, a third embodiment will be described. A vehicle 700 according to Embodiment 3 has a plurality of lithium ion secondary batteries 100 of Embodiment 1 mounted thereon. It is a hybrid electric vehicle driven with using a combination of an engine 740, a front motor 720, and a rear motor 730 as shown in FIG. 22.

More specifically, this vehicle 700 includes a vehicle body 790, the engine 740, and the front motor 720, the rear motor 730, a cable 750, and an inverter 760 which are attached to the engine 740. This vehicle 700 further includes a battery pack 710 containing a plurality of lithium ion secondary batteries 100 therein and uses the electrical energy stored in this battery pack 710 for driving the front motor 720 and the rear motor 730.

As mentioned above, the lithium ion secondary battery 100 can prevent decrease in the apparent battery capacity even when the high-rate discharge or charge is repeated in low temperature environments. Accordingly, the performance of the vehicle 700 having the lithium ion secondary batteries 100 mounted thereon can be maintained high in the long term.

### Embodiment 4

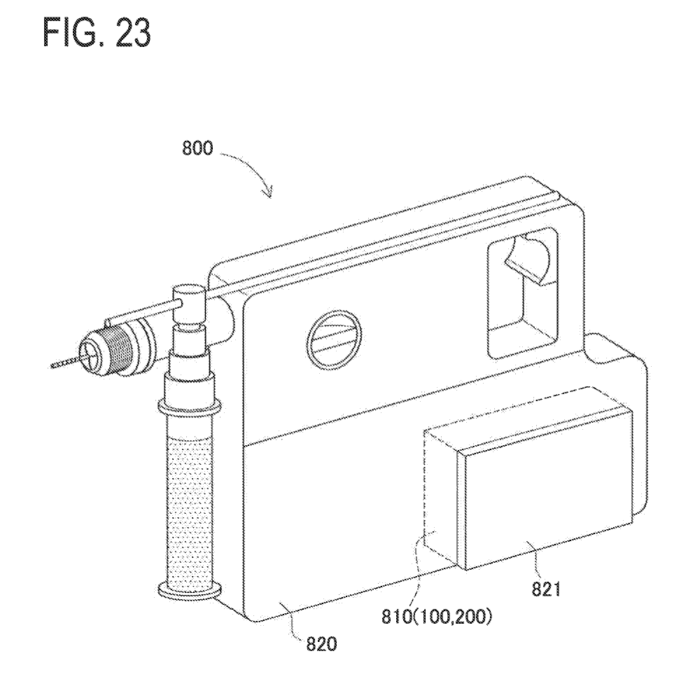

Next, a fourth embodiment will be described. A hammer drill 800 of Embodiment 4 is a battery powered equipment having a battery pack 810 containing the lithium ion secondary batteries 100 of Embodiment 1 mounted thereon, as shown in FIG. 23. More specifically, this hammer drill 800 has the battery pack 810 accommodated in a bottom part 821 of a main body 820, using this battery pack 810 as the energy source for driving the drill.

As mentioned above, the lithium ion secondary battery 100 can prevent decrease in the apparent battery capacity even when the high-rate discharge or charge is repeated in low temperature environments. Accordingly, the performance of the hammer drill 800 having the lithium ion secondary battery 100 mounted thereon can be maintained high in the long term.

The present invention has been described above with respect to Embodiments 1, 3, and 4. However, it will be appreciated that the present invention is not limited to the above-described Embodiments 1, 3, and 4 but may be applied with various changes made thereto without departing from the scope of its subject matter.

For example, the one side fluid flow restrictor 190 in Embodiment 1 includes the first to fourth restrictors 191 to 194. Alternatively, the one side fluid flow restrictor may include at least one of the first to fourth restrictors.

Further, the other side fluid flow restrictor 195 in Embodiment 1 includes the fifth to eighth restrictors 196 to 199. Alternatively, the other side fluid flow restrictor may include at least one of the fifth to eighth restrictors.

1. A secondary battery including:
a wound electrode body formed by winding an elongated positive electrode plate and an elongated negative electrode plate overlapped upon one another via an elongated separator interposed therebetween around an axis; and
electrolyte contained inside the wound electrode body,
wherein the wound electrode body includes a fluid flow restrictor for restricting flow of the electrolyte between inside and outside of the wound electrode body in an axial direction along the axis,
when a portion where the separator exists in a radial direction of the axis of the wound electrode body is defined as an electrode body central part,
the fluid flow restrictor is at least one of:
a one side fluid flow restrictor formed in one axial end portion of one axial end side of the electrode body central part to restrict flow of the electrolyte through the one axial end portion; and
the other side fluid flow restrictor formed in the other axial end portion of the other axial end side of the electrode body central part to restrict flow of the electrolyte through the other axial end portion, and
the one side fluid flow restrictor and the other side fluid flow restrictor are both formed of a gel-like substance containing the electrolyte and being in a form of a gel.

2. (canceled)

3. The secondary battery according to claim 1,
wherein the positive electrode plate is formed by an elongated positive current collecting foil and a positive active material layer formed on a part of the foil,
the positive electrode plate including:
a strip-shaped positive electrode portion, extending in a longitudinal direction of the positive electrode plate, where the positive active material layer is present in a thickness direction of the positive electrode portion; and
a strip-shaped positive current collecting portion, located at one end in a width direction of the positive current collecting foil and formed extending in the longitudinal direction, where the positive active material layer is not present in a thickness direction of the positive current collecting portion,
the negative electrode plate is formed by an elongated negative current collecting foil and a negative active material layer formed in a part of the foil,
the negative electrode plate including:
a strip-shaped negative electrode portion, extending in a longitudinal direction of the negative electrode plate, where the negative active material layer is present in a thickness direction of the negative electrode portion; and
a strip-shaped negative current collecting portion, located at one end in a width direction of the negative current collecting foil and formed extending in the longitudinal direction, where the negative active material layer is not present in the thickness direction of the negative current collecting portion,
the wound electrode body is configured such that
a part of the positive current collecting portion protrudes in a spiral shape from the electrode body central part toward the one axial end side, and
a part of the negative current collecting portion protrudes in a spiral shape from the electrode body central part toward the other axial end side,
the one side fluid flow restrictor is at least one of:
a first restrictor formed in pores in an end portion of the one axial end side of the positive active material layer having a porous structure;
a second restrictor formed between an inner positive collector portion of the positive current collecting portion located inside the electrode body central part and a positive electrode facing portion of the separator facing the inner positive collector portion;
a third restrictor formed in pores in an end portion of the one axial end side of the negative active material layer having a porous structure; and
a fourth restrictor formed between one end facing parts of the separators located at the one axial end side and directly facing each other, and
the other side fluid flow restrictor is at least one of:
a fifth restrictor formed in pores in an end portion of the other axial end side of the negative active material layer having a porous structure;
a sixth restrictor formed between an inner negative collector portion of the negative current collecting portion located inside the electrode body central part and a negative electrode facing portion of the separator facing the inner negative collector portion;
a seventh restrictor formed in pores in an end portion of the other axial end side of the positive active material layer having a porous structure; and
an eighth restrictor formed between the other end facing parts of the separators located at the other axial end side and directly facing each other.

4. (canceled)

5. The secondary battery according to claim 1, that is a secondary battery for use as a vehicle drive power source mounted on a vehicle and used as the drive power source of the vehicle.

6. A method for manufacturing a secondary battery including:
a wound electrode body formed by winding an elongated positive electrode plate and an elongated negative electrode plate overlapped upon one another via an elongated separator interposed therebetween around an axis; and
electrolyte contained inside the wound electrode body,
the wound electrode body including a fluid flow restrictor for restricting flow of the electrolyte between inside and outside of the wound electrode body in an axial direction along the axis,
when a portion where the separator exists in a radial direction of the axis of the wound electrode body is defined as an electrode body central part,
the fluid flow restrictor is at least one of:
a one side fluid flow restrictor formed in one axial end portion of one axial end side of the electrode body central part to restrict flow of the electrolyte through the one axial end portion; and
the other side fluid flow restrictor formed in the other axial end portion of the other axial end side of the electrode body central part to restrict flow of the electrolyte through the other axial end portion, and
the one side fluid flow restrictor and the other side fluid flow restrictor are both formed of a gel-like substance containing the electrolyte and being in a form of a gel,
wherein the method includes:
a pre-processed restrictor formation step of forming a pre-processed fluid flow restrictor which is to be subjected to a predetermined flow restricting process to reduce flowability of the electrolyte through the restrictor in the wound electrode body;
an electrolyte injecting step of injecting the electrolyte into the wound electrode body through the pre-processed fluid flow restrictor after the pre-processed restrictor formation step; and
a restrictor formation step of performing the flow restricting process after the electrolyte injecting step to turn the pre-processed fluid flow restrictor into the fluid flow restrictor,
the pre-processed restrictor formation step includes at least one of:
a step of forming a pre-processed one side fluid flow restrictor that is the pre-processed fluid flow restrictor, formed in the one axial end portion of the one axial end side of the electrode body central part; and
a step of forming a pre-processed the other side fluid flow restrictor that is the pre-processed fluid flow restrictor, formed in the other axial end portion of the other axial end side of the electrode body central part,
the electrolyte injecting step is a step of injecting the electrolyte into the electrode body central part through at least one of the pre-processed one side fluid flow restrictor and the pre-processed the other side fluid flow restrictor, and
the restrictor formation step includes at least one of:
a step of turning the pre-processed one side fluid flow restrictor into the one side fluid flow restrictor; and
a step of turning the pre-processed the other side fluid flow restrictor into the other side fluid flow restrictor,
the pre-processed one side fluid flow restrictor and the pre-processed the other side fluid flow restrictor are both formed of a gelling material that absorbs the electrolyte and turns into a gel when subjected to a heating process, and
the restrictor formation step is a step of performing the heating process as the flow restricting process to form the gel-like substance from the gelling material.

7. (canceled)

8. The secondary battery manufacturing method according to claim 6, wherein
the positive electrode plate is formed by an elongated positive current collecting foil and a positive active material layer formed in a part of the foil,
the positive electrode plate including:
a strip-shaped positive electrode portion, extending in a longitudinal direction, where the positive active material layer is present in a thickness direction of the positive electrode portion; and
a strip-shaped positive current collecting portion, located at one end in a width direction of the positive current collecting foil and formed extending in the longitudinal direction, where the positive active material layer is not present in a thickness direction of the positive current collecting portion,
the negative electrode plate is formed by an elongated negative current collecting foil and a negative active material layer formed in a part of the foil,
the negative electrode plate including:
a strip-shaped negative electrode portion, extending in a longitudinal direction, where the negative active material layer is present in a thickness direction of the negative electrode plate, and
a strip-shaped negative current collecting portion, located at one end in a width direction of the negative current collecting foil and formed extending in the longitudinal direction, where the negative active material layer is not present in a thickness direction of the negative electrode plate,
the wound electrode body is configured such that:
a part of the positive current collecting portion protrudes in a spiral shape from the electrode body central part toward the one axial end side, and
a part of the negative current collecting portion protrudes in a spiral shape from the electrode body central part toward the other axial end side,
the pre-processed restrictor formation step includes at least one of:
a first formation step of forming the pre-processed one side fluid flow restrictor in pores in an end portion of the one axial end side of the positive active material layer having a porous structure;
a second formation step of forming the pre-processed one side fluid flow restrictor between an inner positive collector portion of the positive current collecting portion located inside the electrode body central part and a positive electrode facing portion of the separator facing the inner positive collector portion;
a third formation step of forming the pre-processed one side fluid flow restrictor in pores in an end portion of the one axial end side of the negative active material layer having a porous structure;
a fourth formation step of forming the pre-processed one side fluid flow restrictor between one end facing parts of the separators located at one axial end and directly facing each other;
a fifth formation step of forming the pre-processed the other side fluid flow restrictor on the other side in pores in an end portion of the other axial end side of the negative active material layer having a porous structure;
a sixth formation step of forming the pre-processed the other side fluid flow restrictor between an inner negative collector portion of the negative current collecting portion located inside the electrode body central part and a negative electrode facing portion of the separator facing the inner negative collector portion;
a seventh formation step of forming the pre-processed the other side fluid flow restrictor in pores in an end portion of the other axial end side of the positive active material layer having a porous structure; and
an eighth formation step of forming the pre-processed the other side fluid flow restrictor between the other end facing parts of the separator located at the other axial end and directly facing each other.

9. (canceled)
